(19) United States
(12) Patent Application Publication
(10) Pub. No.: US 2026/0289715 A1
(43) Pub. Date: Sep. 24, 2026

(54) Wearable Tracking Devices Interoperable with Multi-Jurisdictional Server Architecture for Immigration Compliance

(71) Applicant: Manuel Alejandro Rivas, Lodi, NJ (US)

(72) Inventor: Manuel Alejandro Rivas, Lodi, NJ (US)

(21) Appl. No.: 19/571,289

(22) Filed: Mar. 18, 2026

Related U.S. Application Data
(60) Provisional application No. 63/776,792, filed on Mar. 24, 2025.

(51) Int. Cl. G06Q 50/26; H04L 9/32; H04W 4/021

(52) U.S. Cl. CPC G06Q 50/265; H04L 9/3247; H04W 4/021

(57) ABSTRACT

A system and method for real-time immigration compliance monitoring using wearable tracking devices is disclosed. The wearable device, such as a wristband, necklace, or ring, includes a GPS-enabled chip, barcode, panic button, steel fiber reinforcement, and magnetic lock. Location and device-status data are asynchronously transmitted to local and federal law enforcement servers, where data are validated and authenticated using encrypted Internet Protocol (IP) messages and public/private cryptographic management. The system supports tamper detection, geofence-based compliance, buffered reporting during connectivity loss, and dynamic transmission intervals based on battery capacity. Cryptographically protected authorizations control device states, including authorized removal via a secure internal switch. This system addresses the technical problem of inefficient and error-prone manual immigration monitoring by providing secure, automated, and scalable enforcement of compliance. Principal uses include preventing overstays and unauthorized activities by tourists, enabling rapid response to violations or emergencies, and supporting multi-jurisdictional interoperability.

### CROSS REFERENCE TO RELATED APPLICATIONS

This patent application claims the priority benefit of U.S. Utility Patent Application Ser. No. 63/776,792, filed Mar. 24, 2025. The aforementioned disclosure is hereby incorporated by reference herein in its entirety, including all references cited therein.

### FIELD OF TECHNOLOGY

The present disclosure pertains to immigration control technologies, and more specifically to systems and wearable devices for real-time monitoring and compliance enforcement of tourists and temporary visitors.

### BACKGROUND

The monitoring and tracking of tourists and temporary visitors have long been a challenge for governments and law enforcement agencies worldwide. Traditional methods of tracking and managing the influx of tourists often rely on manual processes and documentation, which can be inefficient and prone to errors. For instance, paper-based records and static electronic databases have been used to store information about tourists, but these systems do not provide real-time data or the ability to effectively monitor the location and activities of visitors. As a result, these methods may not be effective in preventing overstays or other violations of immigration policies.

In recent years, various technologies have been developed to improve the monitoring and tracking of tourists. For example, some countries have implemented electronic passport systems, biometric enrollment, and automated screening at ports of entry. Additionally, wearable monitoring devices have been explored for their potential to extend oversight beyond fixed checkpoints and to verify identity in real time. However, these devices have been limited in their ability to integrate with existing law enforcement systems and to provide secure and reliable communication. Furthermore, many existing systems depend heavily on a single communication channel or a persistent online connection, which can undermine reliability, particularly in remote areas or during network outages. Some systems have also relied on periodic manual check-ins, which can be time-consuming and prone to data inaccuracies.

Previous approaches to tracking and monitoring tourists have also included the use of mobile applications and electronic registries. These systems have improved data capture, but they often fail to deliver continuous location monitoring or seamless data sharing among enforcement bodies. Moreover, fragmented data silos have hindered the timely detection of unauthorized movements and complicated cross-jurisdictional coordination. Some systems have attempted to address these issues by using satellite communication links or other forms of wireless communication, but these approaches have been limited by issues of cost, reliability, and security. Other systems have used cryptographic techniques to secure data transmission, but these approaches have been limited by the complexity of key management and the risk of unauthorized access. Previous approaches have also included the use of wearable devices with GPS tracking, but these devices have been limited by their lack of integration with law enforcement systems and their vulnerability to tampering or removal.

In summary, previous approaches to monitoring and tracking tourists have included a range of technologies and methods, from traditional manual processes to more modern electronic and wearable devices. However, none of these approaches have provided a comprehensive solution that combines the features described in this disclosure.

### SUMMARY

The approaches described in this section could be pursued, but are not necessarily approaches that have previously been conceived or pursued. Therefore, unless otherwise indicated, it should not be assumed that any of the approaches described in this section qualify as prior art merely by virtue of their inclusion in this section.

The described techniques relate to improved methods, systems, devices, and apparatuses that support techniques for a wearable tracking device for real-time monitoring and immigration compliance. The present disclosure relates to systems, methods, and wearable tracking devices that cooperate with a secure, multi-jurisdiction server architecture to monitor traveler location and device integrity and to enforce immigration compliance. In some implementations, a wearable tracking device generates location tracking data and device-status data and transmits such data, including via asynchronous messaging over one or more communication links, to a local law enforcement server and a federal law enforcement server. The servers may validate and authenticate the transmitted data using locally identifying information and federally identifying information, respectively, and may issue cryptographically protected authorizations that are consumed by the wearable tracking device and/or an associated secure internal switch to control device states such as reporting modes and authorized removal. The described techniques further support tamper detection, geofence-based compliance determination, buffered reporting during connectivity loss, and traveler-initiated distress signaling via a panic input, thereby providing secure, reliable, and scalable real-time monitoring of travelers across multiple enforcement domains.

A secure tracking method of verifying movement of tourists for real-time monitoring is described. The secure tracking method may include asynchronously sending a registration message to a local law enforcement server based on location tracking data of a tourist, where the local law enforcement server may be coupled to a local law enforcement database. The method may include receiving, from the local law enforcement server, locally identifying information associated with the tourist in response to the registration message. The method may include validating the location tracking data based on the locally identifying information associated with the tourist. The method may include asynchronously sending a validation message associated with validating the location tracking data to a federal law enforcement server, where the federal law enforcement server may be coupled to a federal law enforcement database. The method may include receiving, from the federal law enforcement server, federally identifying information associated with the tourist in response to the validation message. The method may include authenticating the validation message based on the federally identifying information associated with the tourist. The method may include receiving a confirmed traveler request from the tourist. The method may include sending the confirmed traveler request from the tourist to the local law enforcement server. The method may include receiving, from the local law enforcement server, a local traveler authorization associated with the confirmed traveler request, where the local traveler authorization may be received via a traveler programmable user interface, and where the local traveler authorization may include a secure, encrypted Internet Protocol (IP) message using encryption hashed with public and private key management. The method may include sending the confirmed traveler request from the tourist to the federal law enforcement server. The method may include receiving, from the federal law enforcement server, a federal traveler authorization associated with the confirmed traveler request, where the federal traveler authorization may be received via the traveler programmable user interface, and where the federal traveler authorization may include a secure, encrypted IP message using encryption hashed with public and private key management. The method may include performing an authorized tourist verification in accordance with the local traveler authorization and the federal traveler authorization, where the performing of the authorized tourist verification may use a secure internal switch and may be associated with a wearable tracking device worn by a tourist.

A system configured for verifying movement of tourists for real-time monitoring is described. The system may include a processor and memory coupled with the processor, with instructions stored in the memory and executable by the processor. The system may send a registration message asynchronously to a local law enforcement server based on location tracking data of a tourist, where the local law enforcement server may be coupled to a local law enforcement database. The system may receive, from the local law enforcement server, locally identifying information associated with the tourist in response to the registration message. The system may validate the location tracking data based on the locally identifying information associated with the tourist. The system may send a validation message asynchronously, associated with the validated location tracking data, to a federal law enforcement server, where the federal law enforcement server may be coupled to a federal law enforcement database. The system may receive, from the federal law enforcement server, federally identifying information associated with the tourist in response to the validation message. The system may authenticate the validation message based on the federally identifying information associated with the tourist. The system may receive a confirmed traveler request from the tourist. The system may send the confirmed traveler request from the tourist to the local law enforcement server. The system may receive, from the local law enforcement server, a local traveler authorization associated with the confirmed traveler request, where the local traveler authorization may be received via a traveler programmable user interface and may include a secure, encrypted Internet Protocol (IP) message using encryption hashed with public and private key management. The system may send the confirmed traveler request from the tourist to the federal law enforcement server. The system may receive, from the federal law enforcement server, a federal traveler authorization associated with the confirmed traveler request, where the federal traveler authorization may be received via the traveler programmable user interface and may include a secure, encrypted Internet Protocol (IP) message using encryption hashed with public and private key management. The system may perform an authorized tourist verification in accordance with the local traveler authorization and the federal traveler authorization, where the authorized tourist verification may be performed using a secure internal switch and may be associated with a wearable tracking device worn by the tourist.

Another system for verifying movement of tourists for real-time monitoring is described. The system may include means for asynchronously sending a registration message to a local law enforcement server based on location tracking data of a tourist, the local law enforcement server being coupled to a local law enforcement database. The system may include means for receiving, from the local law enforcement server, locally identifying information associated with the tourist in response to the registration message. The system may include means for validating the location tracking data based on the locally identifying information associated with the tourist. The system may include means for asynchronously sending a validation message associated with the validating of the location tracking data to a federal law enforcement server, the federal law enforcement server being coupled to a federal law enforcement database. The system may include means for receiving, from the federal law enforcement server, federally identifying information associated with the tourist in response to the validation message. The system may include means for authenticating the validation message based on the federally identifying information associated with the tourist. The system may include means for receiving a confirmed traveler request from the tourist. The system may include means for sending the confirmed traveler request from the tourist to the local law enforcement server. The system may include means for receiving, from the local law enforcement server, a local traveler authorization associated with the confirmed traveler request, the local traveler authorization being received via a traveler programmable user interface, the local traveler authorization comprising a secure, encrypted Internet Protocol (IP) message using encryption hashed with public and private key management. The system may include means for sending the confirmed traveler request from the tourist to the federal law enforcement server. The system may include means for receiving, from the federal law enforcement server, a federal traveler authorization associated with the confirmed traveler request, the federal traveler authorization being received via the traveler programmable user interface, the federal traveler authorization comprising a secure, encrypted IP message using encryption hashed with public and private key management. The system may include means for performing an authorized tourist verification in accordance with the local traveler authorization and the federal traveler authorization, the performing of the authorized tourist verification using a secure internal switch and being associated with a wearable tracking device worn by a tourist.

A non-transitory computer-readable medium storing code for verifying movement of tourists for real-time monitoring is described. The code may include instructions executable by a processor to asynchronously send a registration message to a local law enforcement server based on location tracking data of a tourist, the local law enforcement server being coupled to a local law enforcement database. The code may include instructions executable by a processor to receive, from the local law enforcement server, locally identifying information associated with the tourist in response to the registration message. The code may include instructions executable by a processor to validate the location tracking data based on the locally identifying information associated with the tourist. The code may include instructions executable by a processor to asynchronously send a validation message associated with the validating of the location tracking data to a federal law enforcement server, the federal law enforcement server being coupled to a federal law enforcement database. The code may include instructions executable by a processor to receive, from the federal law enforcement server, federally identifying information associated with the tourist in response to the validation message. The code may include instructions executable by a processor to authenticate the validation message based on the federally identifying information associated with the tourist. The code may include instructions executable by a processor to receive a confirmed traveler request from the tourist. The code may include instructions executable by a processor to send the confirmed traveler request from the tourist to the local law enforcement server. The code may include instructions executable by a processor to receive, from the local law enforcement server, a local traveler authorization associated with the confirmed traveler request, the local traveler authorization being received via a traveler programmable user interface, the local traveler authorization including a secure, encrypted Internet Protocol (IP) message using encryption hashed with public and private key management. The code may include instructions executable by a processor to send the confirmed traveler request from the tourist to the federal law enforcement server. The code may include instructions executable by a processor to receive, from the federal law enforcement server, a federal traveler authorization associated with the confirmed traveler request, the federal traveler authorization being received via the traveler programmable user interface, the federal traveler authorization including a secure, encrypted IP message using encryption hashed with public and private key management. The code may include instructions executable by a processor to perform an authorized tourist verification in accordance with the local traveler authorization and the federal traveler authorization, the performing of the authorized tourist verification using a secure internal switch and being associated with a wearable tracking device worn by a tourist.

Some examples of the method, systems, and non-transitory computer-readable medium described herein may further include operations, features, means, or instructions for generating location tracking data of the wearable tracking device using a GPS-enabled computer chip within the wearable tracking device.

In some examples of the method, systems, and non-transitory computer-readable medium described herein, receiving the locally identifying information may comprise receiving the locally identifying information in response to a scan of a barcode affixed to the wearable tracking device using a restricted-access application operated by a local authority.

Some examples of the method, systems, and non-transitory computer-readable medium described herein may further include operations, features, means, or instructions for asynchronously sending a tamper alert to at least one of the local law enforcement server and the federal law enforcement server upon detecting an interruption of an electrical tamper-detection conductor within the wearable tracking device.

In some examples of the method, systems, and non-transitory computer-readable medium described herein, receiving the confirmed traveler request from the tourist may comprise detecting two consecutive activations of a panic button on the wearable tracking device.

Some examples of the method, systems, and non-transitory computer-readable medium described herein may further include operations, features, means, or instructions for asynchronously sending at least one of the registration message or the validation message via a satellite communication link.

Some examples of the method, systems, and non-transitory computer-readable medium described herein may further include operations, features, means, or instructions for buffering the location tracking data within the wearable tracking device upon loss of network connectivity and transmitting the buffered location tracking data upon restoration of connectivity.

In some examples of the method, systems, and non-transitory computer-readable medium described herein, validating the location tracking data may comprise comparing the location tracking data to a geofence of authorized travel areas retrieved from the local law enforcement database.

In some examples of the method, systems, and non-transitory computer-readable medium described herein, performing the authorized tourist verification using the secure internal switch may comprise actuating a magnetic lock of the wearable tracking device to permit removal of the wearable tracking device.

Some examples of the method, systems, and non-transitory computer-readable medium described herein may further include operations, features, means, or instructions for dynamically adjusting a transmission interval for asynchronously sending the registration message based on a residual battery capacity of the wearable tracking device.

In some examples of the method, systems, and non-transitory computer-readable medium described herein, performing the authorized tourist verification may further comprise verifying a digital signature included in the federal traveler authorization using a stored federal public cryptographic identifier.

In some examples of the method, systems, and non-transitory computer-readable medium described herein, the wearable tracking device may comprise a steel fiber reinforcement to prevent deliberate physical damage or unauthorized removal.

In some examples of the method, systems, and non-transitory computer-readable medium described herein, the wearable tracking device may be selected from the group consisting of a wristband, a smart necklace, and a smart ring.

In some examples of the method, systems, and non-transitory computer-readable medium described herein, the registration message may include a serial identification code specifically linked to the wearable tracking device.

Some examples of the method, systems, and non-transitory computer-readable medium described herein may further include operations, features, means, or instructions for encrypting all personal and location data stored within the wearable tracking device using public and private cryptographic management.

In some examples of the method, systems, and non-transitory computer-readable medium described herein, the wearable tracking device may be configured to restrict removal or installation to authorized checkpoints.

Some examples of the method, systems, and non-transitory computer-readable medium described herein may further include operations, features, means, or instructions for comparing the location tracking data to a geofence of authorized travel areas retrieved from the local law enforcement database and generating a compliance status based on the comparison.

Some examples of the method, systems, and non-transitory computer-readable medium described herein may further include operations, features, means, or instructions for encrypting the location tracking data and personal information stored within the wearable tracking device using public and private cryptographic key management prior to transmitting the data to the local law enforcement server.

In some examples of the method, systems, and non-transitory computer-readable medium described herein, the wearable tracking device may include a panic button configured to transmit a distress signal to the local law enforcement server in response to three consecutive activations within a predefined time period.

In some examples of the method, systems, and non-transitory computer-readable medium described herein, the wearable tracking device may be configured to transmit a low-battery alert to the local law enforcement server in response to detecting a battery level below a predefined threshold.

In some examples of the method, systems, and non-transitory computer-readable medium described herein, the wearable tracking device may be configured to store location tracking data for a predefined duration in response to a loss of communication with the local law enforcement server.

In some examples of the method, systems, and non-transitory computer-readable medium described herein, the wearable tracking device may be configured to generate a tamper alert in response to detecting a magnetic field disruption near the magnetic lock.

In some examples of the method, systems, and non-transitory computer-readable medium described herein, the wearable tracking device may be configured to transmit a compliance status update to the local law enforcement server in response to detecting entry into or exit from a predefined geofence.

Some examples of the method, systems, and non-transitory computer-readable medium described herein may further include operations, features, means, or instructions for transmitting a periodic status report to the local law enforcement server. The periodic status report may include location tracking data and a device integrity status.

In some examples of the method, systems, and non-transitory computer-readable medium described herein, the wearable tracking device may be configured to deactivate the magnetic lock in response to receiving an authorized removal command from the local law enforcement server.

In some examples of the method, systems, and non-transitory computer-readable medium described herein, the wearable tracking device may be configured to transmit an alert to the local law enforcement server in response to detecting a predefined pattern of physical impact on the device.

According to some embodiments, the present technology is directed to methods and systems for preventing immigration irregularities by requiring tourists entering a country to wear a tracking device. For example, a method involves installing a wearable tracking device upon clearance at a point of entry, where the device monitors the individual's location and stores relevant personal information during their visit. The collected data is used to verify compliance with immigration and customs regulations, such that if a traveler violates stipulated requirements or attempts to remove the device without authorization, an alert is generated for prompt intervention by designated authorities.

In another embodiment, the disclosure describes an apparatus comprising a wristband that is configured to monitor a traveler's movements and record personal identification details. The wristband includes a barcode for quick access to basic traveler information, a chip that securely stores personal data and current location, and an electrical component that acts as a detector for unauthorized removal. Additional integrated features include a panic button that, when activated consecutively, sends an alert to a dedicated monitoring department available twenty-four hours a day, a steel fiber reinforcement to prevent deliberate damage, and a magnetic lock that ensures the device can only be removed or reinstalled at authorized checkpoints such as airports. The wristband is designed to be reusable, thereby helping to lower overall expenses.

In yet another embodiment, the disclosure incorporates measures for enforcing compliance and deterring tampering with the device. Under this approach, if a traveler removes the wristband in contravention of established protocols, sanctions may be imposed, such as fines of up to $1,000 per day or a term of incarceration lasting thirty days. In instances where the device is dislodged accidentally, the traveler is required to promptly report the incident to receive guidance on obtaining a replacement, including assignment of a new serial identification code if necessary. Furthermore, the system contemplates conditions that restrict travel, such as disallowing travel for individuals, for example, with a gestation period exceeding five months unless they are returning to their country of origin. These embodiments, along with their attendant features, work together to enhance monitoring of tourist activities while ensuring adherence to proper immigration protocols.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 shows a perspective view of a person equipped with a system of wearable tracking devices for real-time monitoring and immigration compliance in accordance with aspects of the present disclosure.

FIG. 2 illustrates an example of a system for data processing that supports a wearable tracking device for real-time monitoring and immigration compliance in accordance with aspects of the present disclosure.

FIG. 3 shows a wristband diagram that supports techniques for a wearable tracking device for real-time monitoring and immigration compliance in accordance with various aspects of the present disclosure.

FIG. 4A shows a smart necklace diagram that supports techniques for a wearable tracking device for real-time monitoring and immigration compliance in accordance with various aspects of the present disclosure.

FIG. 4B shows a ring device that supports techniques for a wearable tracking device for real-time monitoring and immigration compliance in accordance with various aspects of the present disclosure.

FIG. 5 illustrates an example of a process flow that supports a wearable tracking device for real-time monitoring and immigration compliance in accordance with various aspects of the present disclosure.

FIG. 6 shows a block diagram of an apparatus that supports a wearable tracking device for real-time monitoring and immigration compliance in accordance with various aspects of the present disclosure.

FIG. 7 shows a block diagram of a secure tracking component that supports a wearable tracking device for real-time monitoring and immigration compliance in accordance with various aspects of the present disclosure.

FIG. 8 shows a diagram of a system including a device that supports a wearable tracking device for real-time monitoring and immigration compliance in accordance with various aspects of the present disclosure.

FIG. 9 shows a flowchart illustrating methods that support a wearable tracking device for real-time monitoring and immigration compliance in accordance with various aspects of the present disclosure.

FIG. 10 shows a flowchart illustrating methods that support a wearable tracking device for real-time monitoring and immigration compliance in accordance with various aspects of the present disclosure.

### DESCRIPTION OF EXEMPLARY EMBODIMENTS

Methods, systems, devices, and apparatuses that support techniques for a wearable tracking device for real-time monitoring and immigration compliance are disclosed.

While this technology is susceptible of embodiments in many different forms, there are shown in the drawings, and there are described in detail several specific embodiments with the understanding that the present disclosure is to be considered as an exemplification of the principles of the technology and is not intended to limit the technology to the embodiments illustrated.

The present disclosure relates to systems, methods, and wearable tracking devices configured to interoperate with a secure, multi-jurisdiction server architecture to monitor traveler location and device integrity and to enforce immigration compliance. In some implementations, a wearable tracking device generates location tracking data and device-status data and transmits the data via asynchronous messaging over one or more communication links to a local law enforcement server and a federal law enforcement server. The local law enforcement server and the federal law enforcement server may, respectively, validate and authenticate the transmitted data using locally identifying information and federally identifying information, and may generate cryptographically protected authorizations that are consumable by the wearable tracking device and/or an associated secure internal switch to control device operational states, including reporting modes and authorized removal states. The disclosed techniques further support tamper detection, geofence-based compliance determination, buffered reporting during loss of connectivity with subsequent transmission upon restoration, and traveler-initiated distress signaling via a panic input, thereby providing secure, reliable, and scalable real-time monitoring of travelers across multiple enforcement domains.

The systems, methods, and wearable tracking devices described herein provide technical benefits and advantages that improve security, reliability, and interoperability of traveler monitoring across multiple enforcement domains. In some implementations, asynchronous messaging between a wearable tracking device and geographically distributed servers improves operational continuity by permitting the wearable tracking device to transmit location tracking data and device-status data without requiring a persistent, always-on session. This architecture can reduce communication overhead, support intermittent connectivity conditions, and facilitate scalable ingestion of device reports across large traveler populations.

In some implementations, multi-jurisdiction validation and authentication improve the integrity of compliance determinations by enabling a local law enforcement server to validate location tracking data using locally identifying information while enabling a federal law enforcement server to authenticate corresponding validation messages using federally identifying information. By separating validation and authentication operations across distinct authority domains, the system can reduce the likelihood of fraudulent use of identifiers, mitigate unauthorized access to sensitive records, and provide a structured audit trail for compliance decisions.

In some implementations, cryptographically protected authorizations improve the security of device state control by permitting only authorized entities to command changes in operational states of the wearable tracking device, including changes to reporting modes and authorization of device removal. The use of digitally signed and encrypted authorizations can reduce susceptibility to spoofing, replay, and man-in-the-middle attacks, while enabling verifiable attribution of state changes to a particular authority.

In some implementations, a secure internal switch that consumes multi-source authorizations improves tamper resistance and prevents unauthorized removal by requiring receipt and verification of required authorizations prior to actuating a magnetic lock or otherwise enabling device removal. This approach can reduce circumvention attempts because a physical removal action is gated by cryptographic verification performed locally at the device.

In some implementations, tamper detection improves the integrity of monitoring by generating a tamper alert upon detection of interruption of an electrical tamper-detection conductor, detection of a magnetic field disruption near a magnetic lock, detection of an impact pattern indicative of misuse, or other integrity events. Rapid generation and transmission of tamper alerts can shorten response times and improve situational awareness for enforcement personnel.

In some implementations, geofence-based compliance determination improves accuracy and responsiveness by comparing location tracking data to authorized travel areas retrieved from an enforcement database, thereby enabling detection of entry into or exit from predefined areas. Event-driven compliance status updates can reduce unnecessary reporting traffic while enabling prompt notice of potential violations.

In some implementations, buffered reporting improves reliability by storing location tracking data locally upon loss of connectivity and transmitting the buffered location tracking data upon restoration of connectivity. This approach can reduce data loss, improve continuity of travel histories, and provide more complete records for retrospective compliance analysis.

In some implementations, adaptive transmission intervals improve device operability by dynamically adjusting reporting frequency based on residual battery capacity and other operating conditions. Such power-aware reporting can extend the operational life of the wearable tracking device while maintaining sufficient reporting granularity for compliance monitoring.

In some implementations, traveler-initiated distress signaling improves safety by enabling a traveler to transmit an emergency alert through a panic input, including detection of two or more consecutive activations within a predefined time period to reduce accidental triggers. The resulting distress signaling can improve response coordination by providing both identity context and location context with the alert.

In some implementations, interoperability across wearable form factors improves deployability by enabling the described monitoring and authorization techniques to be implemented in multiple device types, including wristbands, necklaces, and rings, and by supporting multiple communication links, including satellite communication links. This flexibility can improve coverage and adoption in diverse operating environments.

In recent years, the issue of immigration irregularities has become a significant concern for governments worldwide. The movement of tourists and temporary visitors across international borders presents challenges in monitoring and ensuring compliance with immigration laws. Traditional methods of tracking and managing the influx of tourists often rely on manual processes and documentation, which can be inefficient and prone to errors. These methods may not provide real-time data or the ability to effectively monitor the location and activities of visitors, leading to potential overstays and other violations of immigration policies.

Existing systems for managing tourist information and ensuring compliance with immigration regulations have several disadvantages. Many rely on paper-based records or static electronic databases that do not offer dynamic tracking capabilities. These systems often lack integration with law enforcement and other governmental agencies, making responding promptly to violations or emergencies challenging. Additionally, the absence of a centralized monitoring system can result in fragmented data, complicating the maintenance of accurate records of tourist activities and compliance status. The lack of real-time monitoring and enforcement can lead to increased instances of visa overstays and other immigration-related issues.

The present technology addresses these challenges by introducing a tracking mechanism designed to monitor tourists and temporary visitors in real-time. The system utilizes a wearable device, such as a wristband, smart collar, or smart ring, equipped with advanced tracking and identification technologies. This wearable device is capable of storing and transmitting personal and location data, allowing for continuous monitoring of the wearer's movements and activities. The system aims to enhance the efficiency of immigration management by providing a comprehensive solution that integrates with existing governmental systems, ensuring that tourists comply with immigration regulations while offering a secure and user-friendly experience.

According to various embodiments, the present technology includes a wearable tracking wristband for tracking tourists entering the United States or other countries. The wristband incorporates a barcode, chip, electric wire, panic button, steel fiber, and magnetic lock, all integrated with a software system for monitoring purposes. The wristband stores personal information and tracks the wearer's location. The design aims to prevent immigration irregularities by ensuring tourists adhere to visa regulations and settle any fines or medical bills incurred during their stay. The system includes a monitoring department to manage alerts and suspicious activities. Sanctions are imposed for unauthorized removal of the wristband, with allowances made for accidental damage. The wristband is intended to be reusable to reduce costs. The proposed system seeks to enhance immigration control and create employment opportunities.

Aspects of the disclosure are described in the context of networked computing systems. Aspects of the disclosure are additionally illustrated by and described with reference to example implementations. Aspects of the disclosure are further illustrated by and described with reference to apparatus diagrams, system diagrams, and flowcharts that relate to a wearable tracking device for real-time monitoring and immigration compliance.

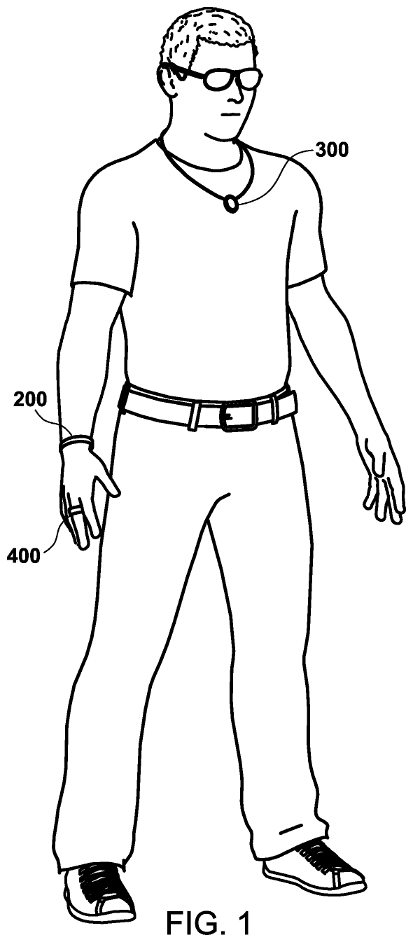

FIG. 1 shows a perspective view of a person equipped with a system of wearable tracking devices for real-time monitoring and immigration compliance in accordance with aspects of the present disclosure. FIG. 1 depicts the wearable tracking devices in three alternative configurations: a wristband 200, a smart necklace 300, and a ring device 400, each worn on the corresponding part of the body. The environment illustrated is representative of a traveler or tourist subject to immigration monitoring protocols according to various embodiments.

According to various embodiments, the wristband 200 is shown secured around the wrist and comprises a GPS-enabled computer chip for generating location tracking data, a barcode for accessing traveler information, an electric component for power connection, a panic button for sending alerts to enforcement authorities, steel fiber reinforcement to prevent deliberate physical damage or unauthorized removal, and a magnetic lock for securing the device to the wrist. The wristband 200 may be reusable to lower operational costs.

According to various embodiments, the smart necklace 300 is depicted worn around the neck and includes a computer chip for tracking and information access, an electric component for power, and a panic button for emergency signaling. The smart necklace 300 may also incorporate steel fiber reinforcement and a magnetic lock, similar to the wristband 200, to ensure secure attachment and tamper resistance.

According to various embodiments, the ring device 400 is shown worn on a finger and provides a compact alternative for real-time monitoring. The ring device 400 may include a computer chip for tracking, an electric component for power, and a panic button, and may be constructed with steel fiber reinforcement and a magnetic lock for security and durability.

According to some embodiments, each of the wearable tracking devices is configured to interoperate with a secure, multi-jurisdiction server architecture, enabling asynchronous transmission of location and device-status data to local and federal law enforcement servers. The devices may be implemented in various form factors, including but not limited to wristbands, necklaces, and rings, to accommodate different user preferences and operational requirements. The system supports features such as tamper detection, geofence-based compliance determination, buffered reporting during connectivity loss, and traveler-initiated distress signaling, as described in the claims.

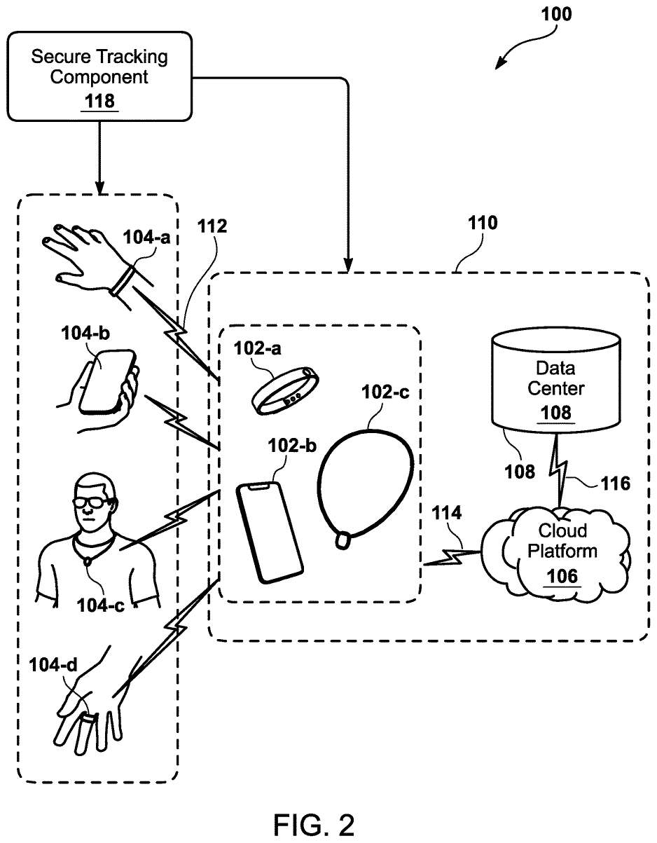

FIG. 2 illustrates an example of a system 100 that supports a wearable tracking device for real-time monitoring and immigration compliance in accordance with various aspects of the present disclosure. The system 100 includes cloud clients 102, user devices 104, a cloud platform 106, and a data center 108. Cloud platform 106 may be an example of a public or private cloud network. A cloud client 102 may access cloud platform 106 over a network connection 114. The network connection 114 may include a wired connection, a wireless connection, or both. The network may implement transfer control protocol and internet protocol (TCP/IP), such as the Internet, or may implement other network protocols. A cloud client 102 may be an example of a computing device, such as a wearable device (e.g., cloud client 102-a), a smartphone (e.g., cloud client 102-b), or a server (e.g., cloud client 102-d). In other examples, a cloud client 102 may be a laptop computer (e.g., cloud client 102-c), a tablet, a sensor, or another computing device or system capable of generating, analyzing, transmitting, or receiving communications.

A cloud client 102 may facilitate communication between the data center 108 and one or multiple user devices 104 to implement an online environment. The network connection 112 may include communications, regulation, tracking, or any other interaction between a cloud client 102 and a user device 104. The network connection 112 may include a wired connection, a wireless connection, or both. A cloud client 102 may access cloud platform 106 to store, manage, and process the data communicated via one or more network connections 112. In some cases, the cloud client 102 may have an associated security or permission level. A cloud client 102 may have access to certain applications, data, and database information within cloud platform 106 based on the associated security or permission level, and may not have access to others.

The user device 104 may include a secure tracking component 118 (e.g., a wearable tracking device worn by a tourist). The user device 104 may interact with the cloud client 102 over network connection 112. The network may implement transfer control protocol and internet protocol (TCP/IP), such as the Internet, or may implement other network protocols. The network connection 112 may facilitate transport of data via email, web, text messages, mail, or any other appropriate form of electronic interaction via a computer network. In an example, the user device 104 may be a computing device such as a wristband 104-a, a smartphone 104-b, a necklace 104-c, or a ring 104-d. In other cases, the user device 104 may be another computing system. In some cases, the user device 104 may be operated by a user or group of users. The user or group of users may be a tourist, a traveler, a visitor, temporary entrant, visa holder, foreign national, passenger, guest, business traveler, student traveler, exchange visitor, seasonal worker, transit passenger, crew member, seafarer, airline crew, diplomatic visitor, refugee applicant, asylum applicant, and so forth.

Cloud platform 106 may offer an on-demand database service to the cloud client 102. In some cases, cloud platform 106 may be an example of a multi-tenant database system. In this case, cloud platform 106 may serve multiple cloud clients 102 with a single instance of software. However, other types of systems may be implemented, including, but not limited to, client-server systems, mobile device systems, and mobile network systems. In some cases, cloud platform 106 may support an online application. This may include support for law enforcement and tourists operating user devices, analytics, such as user-interaction metrics, applications (e.g., computer vision and machine learning), and the Internet of Things (IoT). Cloud platform 106 may receive data associated with the generation of an online environment from the cloud client 102 over network connection 114, and may store and analyze the data. In some cases, cloud platform 106 may receive data directly from a user device 104 and the cloud client 102. In some cases, the cloud client 102 may develop applications to run on cloud platform 106. Cloud platform 106 may be implemented using remote servers. In some cases, the remote servers may be located at one or more data centers 108.

Data center 108 may include multiple servers. The multiple servers may be used for data storage, management, and processing. Data center 108 may receive data from cloud platform 106 via connection 116, or directly from the cloud client 102 or via network connection 112 between the user device 104 and the cloud client 102. The connection 116 may include a wired connection, a wireless connection, or both. Data center 108 may utilize multiple redundancies for security purposes. In some cases, the data stored at data center 108 may be backed up by copies of the data at a different data center (not pictured).

Server system 110 may include cloud clients 102, a cloud platform 106, a secure tracking component 118, and a data center 108 that may coordinate with cloud platform 106 and data center 108 to implement an online environment. In some cases, data processing may occur at any of the components of server system 110, or at a combination of these components. Thus, the secure tracking component 118 may be included in the user device 104, server system 110, or in part or in whole in both. In some cases, servers may perform the data processing. The servers may be a cloud client 102 or located at data center 108.

Some or all of the functionality attributed to the secure tracking component 118 may be embodied or performed by one or more user devices, one or more components of server system 110 (e.g., cloud clients 102, a cloud platform 106, and/or a data center 108), and/or other components of system 100. The secure tracking component 118 may receive signals and inputs from user device 104 directly via cloud clients 102, and/or via cloud platform 106 or data center 108.

As described herein, the secure tracking component 118 (e.g., a wearable tracking device worn by a tourist) may facilitate real-time monitoring and verification of tourist movement by integrating location tracking data with local and federal law enforcement databases. The secure tracking component 118 may asynchronously transmit registration messages containing location tracking data to a local law enforcement server, which may validate the data and provide locally identifying information associated with the tourist. The secure tracking component 118 may further transmit validation messages to a federal law enforcement server, which may authenticate the data and provide federally identifying information. Upon receiving a confirmed traveler request from the tourist via a traveler programmable user interface, the secure tracking component 118 may coordinate with the local and federal law enforcement servers to obtain local and federal traveler authorizations, respectively. These authorizations may include secure, encrypted IP messages hashed with public and private key management. The secure tracking component 118 may then perform an authorized tourist verification using a secure internal switch, ensuring compliance with the received authorizations and enabling seamless integration with the wearable tracking device.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

Alternatives for the secure tracking component 118 include implementation in various wearable formats, such as wristbands, smart necklaces, or smart rings, each comprising a GPS-enabled chip, barcode, panic button, steel fiber reinforcement, and magnetic lock. The system may further support satellite communication links, geofence-based compliance determination, and encrypted data transmission using public and private cryptographic management systems. FIG. 2 thus illustrates a comprehensive, networked system architecture for real-time monitoring and immigration compliance, integrating wearable tracking devices, cloud computing, and secure data management in a multi-jurisdictional enforcement environment.

According to some embodiments, the user device 104 may include the secure tracking component 118 (e.g., a wearable tracking device worn by a tourist), which may include the wearable tracking wristband, the smart necklace 300, and the ring device 400.

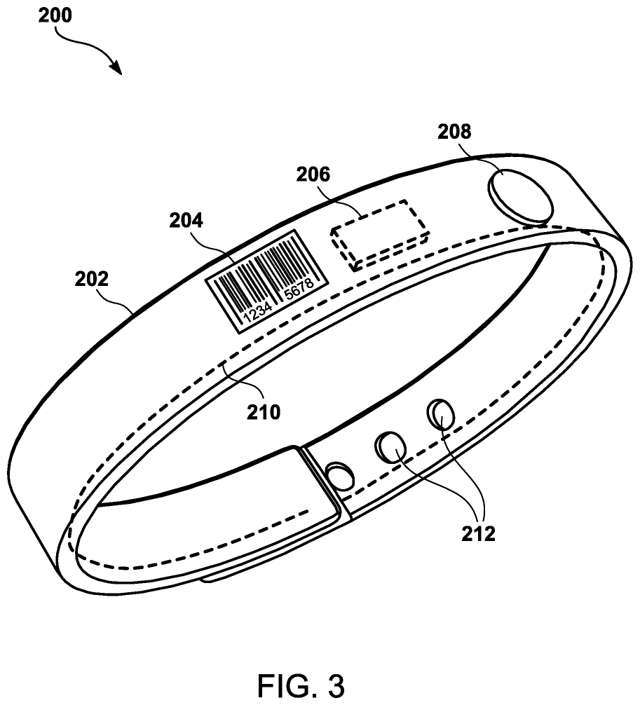

FIG. 3 shows a perspective diagram of a wristband 200 configured for real-time monitoring and immigration compliance. The wristband 200 is depicted in a configuration suitable for secure attachment to a tourist's wrist within an immigration control environment, such as a port of entry, airport, or other authorized checkpoint.

The wristband body 202 forms the main structure and is designed for durability and tamper resistance, supporting the integration of multiple functional components. The wristband body 202 may be constructed from reinforced materials, such as steel fiber, to prevent deliberate physical damage or unauthorized removal, and may be reusable to lower operational costs.

According to some embodiments, a barcode 204 is affixed to the wristband body 202, enabling access to traveler information, including name, address, passport number, and date of exit. The barcode 204 may be scanned by a restricted-access application operated by local authorities, and may be supplemented or replaced by a serial identification code or QR code for rapid identification and compliance verification.

According to some embodiments, a chip 206 is embedded within the wristband body 202, wherein the chip 206 is GPS-enabled and generates location tracking data for the tourist. The chip 206 may also store personal information and support asynchronous communication with law enforcement servers. In alternative embodiments, the chip 206 may be implemented in other wearable formats, such as a smart necklace or smart ring.

According to some embodiments, a panic button 208 is positioned on the wristband body 202, allowing the wearer to send an alert to enforcement authorities. The panic button 208 is configured to require two consecutive activations within a predefined interval to trigger a confirmed traveler request, thereby minimizing accidental distress signals. The panic button 208 may be supplemented by visual or audio indicators to confirm activation.

According to some embodiments, an electric wire 210 is embedded within the wristband body 202, functioning as a tamper-detection conductor. The electric wire 210 generates a tamper alert if interrupted, such as by cutting or removal attempts, and transmits this alert to law enforcement servers. In alternative embodiments, the tamper-detection mechanism may include magnetic field disruption sensors or impact sensors.

According to some embodiments, a magnetic lock 212 is incorporated into the wristband body 202 to secure the device to the wearer's wrist. The magnetic lock 212 is controlled by a secure internal switch and may only be actuated upon receipt and verification of cryptographically protected authorizations from local and federal law enforcement servers. The magnetic lock 212 restricts removal or installation to authorized checkpoints and may be implemented in various locking mechanisms, including electromagnetic or mechanical systems.

According to some embodiments, the wristband 200, as shown in FIG. 3, is situated within a broader system environment for immigration compliance, supporting secure, real-time monitoring, tamper detection, distress signaling, and integration with multi-jurisdictional law enforcement infrastructure. Examples and alternatives for the wristband 200 include implementation as a smart necklace or smart ring, each comprising the described components and supporting the same compliance and monitoring functions.

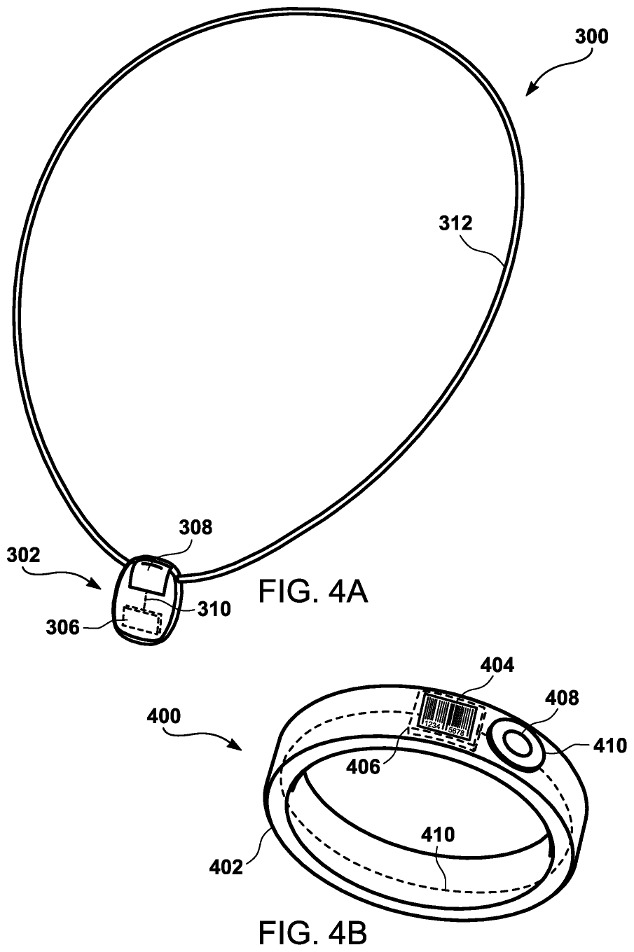

FIG. 4A shows a perspective diagram of the smart necklace 300 configured for real-time monitoring and immigration compliance, depicted in a configuration suitable for secure attachment around a tourist's neck within an immigration control environment, such as a port of entry, airport, or other authorized checkpoint. The smart necklace 300 is presented as an alternative wearable tracking device to the wristband 200 and the ring device 400, offering a neck-worn form factor for user comfort and operational flexibility.

According to some embodiments, the smart necklace 300 includes a pendant housing 302, which contains a GPS-enabled computer chip 306 for generating location tracking data and storing personal information. The GPS-enabled computer chip 306 may operate using satellite communication to ensure continuous location tracking, and may be implemented in other wearable formats, such as wristbands or rings. The pendant housing 302 further integrates a panic button 308, configured to require two consecutive activations within a predefined interval to transmit a distress signal to enforcement authorities, thereby minimizing accidental triggers and supporting traveler-initiated emergency signaling.

According to some embodiments, a magnetic lock 310 is incorporated into the pendant housing 302 to secure the smart necklace 300 around the wearer's neck. The magnetic lock 310 is controlled by a secure internal switch and may only be actuated upon receipt and verification of cryptographically protected authorizations from local and federal law enforcement servers, restricting removal or installation to authorized checkpoints. The necklace band 312 is constructed for durability and tamper resistance, comprising steel fiber reinforcement to prevent deliberate physical damage or unauthorized removal, and may be implemented in alternative wearable tracking devices, such as wristbands or rings.

According to some embodiments, the smart necklace 300 is further configured to interoperate with a secure, multi-jurisdiction server architecture, enabling asynchronous transmission of location and device-status data, tamper detection, geofence-based compliance determination, buffered reporting during connectivity loss, and traveler-initiated distress signaling. Examples and alternatives for the smart necklace 300 include implementation as a wristband or smart ring, each comprising the described components and supporting the same compliance and monitoring functions.

FIG. 4B shows a ring device that supports techniques for a wearable tracking device for real-time monitoring and immigration compliance in accordance with various aspects of the present disclosure. The ring device 400 includes a compact housing 402 that contains a GPS-enabled computer chip 406 for generating location tracking data and storing personal information. The GPS-enabled computer chip 406 operates using satellite communication to ensure continuous location tracking, and may be configured to interoperate with secure government-operated servers for data transmission and compliance verification. The ring device 400 includes a barcode 404 that is affixed to the compact housing 402, enabling access to traveler information including name, address, passport number, and date of exit. The barcode 404 may be scanned by a restricted-access application operated by local authorities, and may be supplemented or replaced by a serial identification code or QR code for rapid identification and compliance verification.

According to some embodiments, the ring device 400 further incorporates a panic button 408, which is designed to require two consecutive activations within a predefined interval to transmit a distress signal to enforcement authorities, thereby reducing the likelihood of accidental alerts. A magnetic lock 412 is integrated into the ring device 400 to secure the device on the wearer's finger, with removal or installation restricted to authorized personnel at designated checkpoints. The compact housing 402 is reinforced with steel fiber to prevent unauthorized removal or physical tampering, and includes an electric wire 410 for detecting removal or breakage events.

According to some embodiments, the ring device 400 is configured to support asynchronous transmission of location and device-status data, tamper detection, geofence-based compliance determination, and traveler-initiated distress signaling. The ring device 400 may be implemented as an alternative to other wearable tracking devices, such as a wristband or necklace, each comprising similar components and supporting the same monitoring and compliance functions.

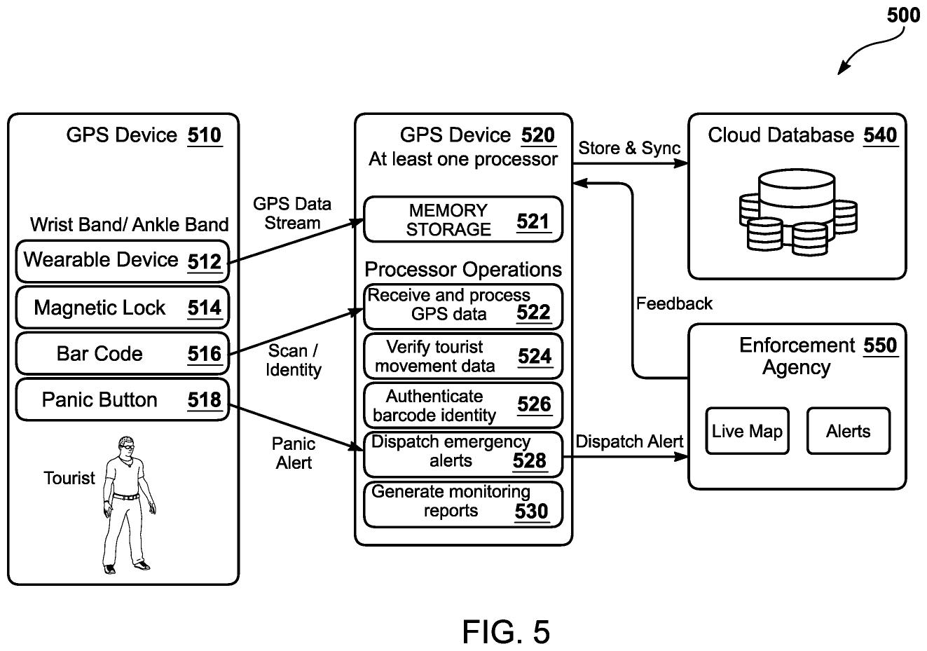

FIG. 5 shows a process flow diagram of a tourist tracking system configured for real-time monitoring and immigration compliance, as implemented in a secure, multi-jurisdictional enforcement environment according to some embodiments. FIG. 5 is presented from a functional perspective, illustrating the interaction between a wearable tracking device 510 and various system components, including data processing units 520, cloud databases 540, and enforcement agencies 550.

According to some embodiments, the wearable tracking device 510 is depicted in a configuration suitable for attachment to a tourist, such as a wristband, ankle band, smart necklace, or smart ring. The device includes a GPS device 512 for generating location tracking data, wherein the GPS device 512 may be implemented as a GPS-enabled computer chip and may operate using satellite communication to ensure continuous location tracking. The device further comprises a Wrist Band/Ankle Band, which may be constructed with steel fiber reinforcement to prevent deliberate physical damage or unauthorized removal, and may be reusable to lower operational costs. A Magnetic Lock 514 is integrated to secure the device to the tourist, wherein the Magnetic Lock 514 may be actuated only upon receipt and verification of cryptographically protected authorizations from local and federal law enforcement servers, restricting removal or installation to authorized checkpoints.

According to some embodiments, a bar code 516 is affixed to the wearable device, enabling access to traveler information such as name, address, passport number, and date of exit. The bar code 516 may be scanned by a restricted-access application operated by local authorities, and may be supplemented or replaced by a serial identification code or QR code for rapid identification and compliance verification. The device also includes a panic button 518, configured to transmit a distress signal to enforcement agencies in response to two consecutive activations within a predefined interval, thereby minimizing accidental triggers. The panic button 518 may be implemented in various wearable formats and supplemented by visual or audio indicators to confirm activation.

According to some embodiments, the GPS Device 512 is for receiving and processing location tracking data from the wearable tracking device 510. A memory 521 is provided for storing location tracking data, device integrity status, and other relevant information, wherein the memory 521 may comprise random-access memory (RAM), read-only memory (ROM), or other non-transitory computer-readable media. Processor operations 522 execute functions such as verifying tourist movements 524 by comparing location tracking data to geofences of authorized travel areas retrieved from enforcement databases, authenticating multimedia data 526 using cryptographic techniques, dispatching emergency alerts 528 in response to panic button activations or tamper detection events, and generating monitoring reports 530 for periodic compliance summaries.

According to some embodiments, a cloud database 540 is depicted as a centralized repository for storing and synchronizing data received from wearable devices, supporting secure access and retrieval of information by authorized entities. The enforcement agency 550 is shown as the recipient of alerts and monitoring reports, utilizing a live map interface to track tourist movements in real time and providing feedback to the system for further processing.

Examples and alternatives for the wearable tracking device include implementation as a wristband, smart necklace, or smart ring, each comprising the described components and supporting the same compliance and monitoring functions. The system may further support satellite communication links, geofence-based compliance determination, and encrypted data transmission using public and private cryptographic management systems.

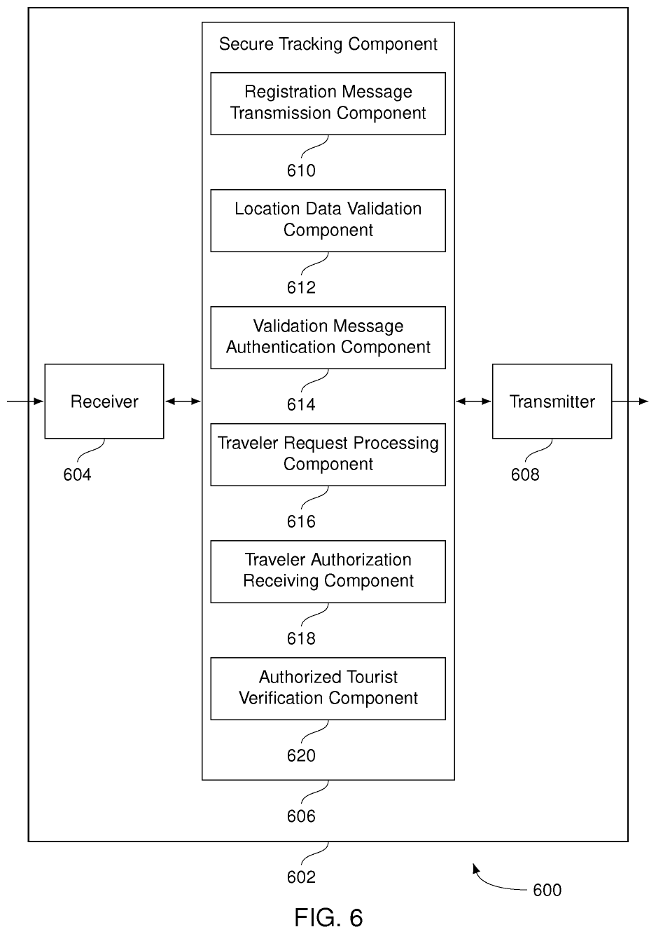

FIG. 6 shows a block diagram 600 of an apparatus 602 that supports a wearable tracking device for real-time monitoring and immigration compliance in accordance with various aspects of the present disclosure. The apparatus 602 may include an input module 604 (e.g., receiver), a secure tracking component 606, and an output module 608 (e.g., transmitter). The apparatus 602 may also include a processor. Each of these components may be in communication with one another (e.g., via one or more buses). In some cases, the apparatus 602 may be an example of a user terminal, a database server, or a system containing multiple computing devices.

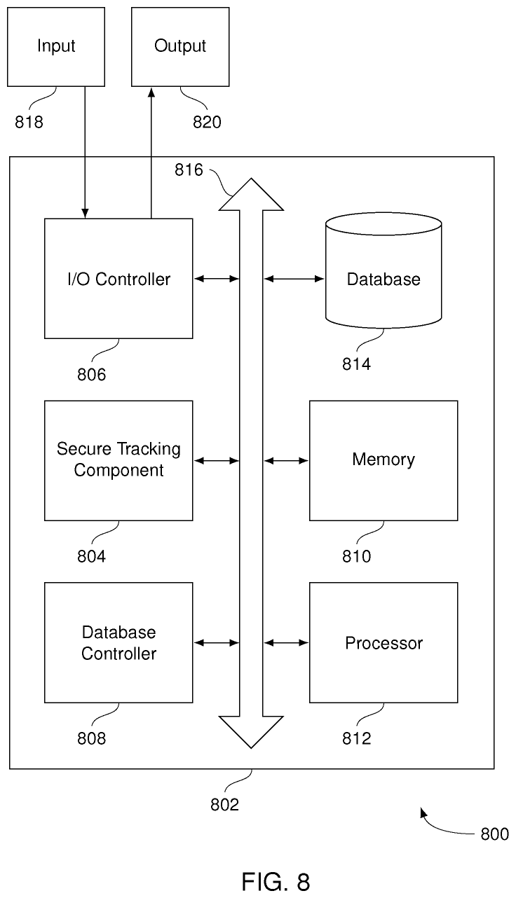

The input module 604 may manage input signals for the apparatus 602. For example, the input module 604 may identify input signals based on an interaction with a modem, a keyboard, a mouse, a touchscreen, or a similar device. These input signals may be associated with user input or processing at other components or devices. In some cases, the input module 604 may utilize an operating system such as iOS®, ANDROID®, MS-DOS®, MS-WINDOWS®, OS/2®, UNIX®, LINUX®, or another known operating system to handle input signals. The input module 604 may send aspects of these input signals to other components of the apparatus 602 for processing. In some cases, the input module 604 may be a component of an input/output (I/O) controller 806 as described with reference to FIG. 8.

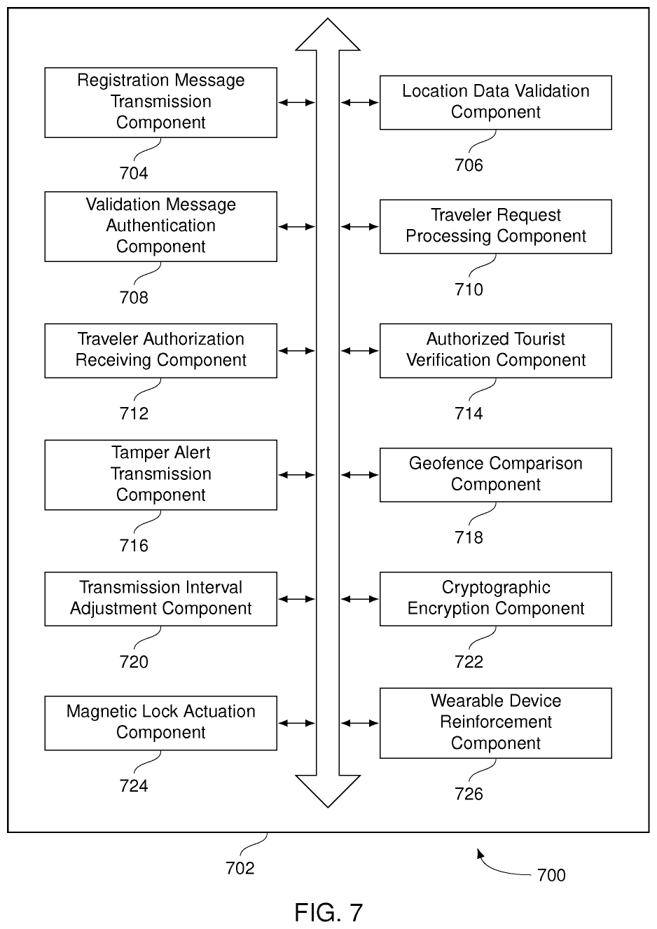

The secure tracking component 606 may include one or more of a registration message transmission component 610, a location data validation component 612, a validation message authentication component 614, a traveler request processing component 616, a traveler authorization receiving component 618, an authorized tourist verification component 620, and/or other components. The secure tracking component 606 may be an example of aspects of the secure tracking component 702 described with reference to FIG. 7 or the secure tracking component 804 described with reference to FIG. 8.

The registration message transmission component 610 may be configured as or otherwise support a means for asynchronously sending a registration message to a local law enforcement server based on location tracking data of a tourist, wherein the local law enforcement server may be coupled to a local law enforcement database. The location data validation component 612 may be configured as or otherwise support a means for receiving, from the local law enforcement server, locally identifying information associated with the tourist in response to the registration message and validating the location tracking data based on the locally identifying information associated with the tourist. The validation message authentication component 614 may be configured as or otherwise support a means for asynchronously sending a validation message associated with the validated location tracking data to a federal law enforcement server, wherein the federal law enforcement server may be coupled to a federal law enforcement database, and receiving, from the federal law enforcement server, federally identifying information associated with the tourist in response to the validation message, and authenticating the validation message based on the federally identifying information associated with the tourist. The traveler request processing component 616 may be configured as or otherwise support a means for receiving a confirmed traveler request from the tourist and sending the confirmed traveler request to the local law enforcement server. The traveler authorization receiving component 618 may be configured as or otherwise support a means for receiving, from the local law enforcement server, a local traveler authorization associated with the confirmed traveler request, wherein the local traveler authorization may be received via a traveler programmable user interface and may comprise a secure, encrypted IP message using encryption hashed with public and private key management, and for sending the confirmed traveler request to the federal law enforcement server and receiving, from the federal law enforcement server, a federal traveler authorization associated with the confirmed traveler request, wherein the federal traveler authorization may be received via the traveler programmable user interface and may comprise a secure, encrypted IP message using encryption hashed with public and private key management. The authorized tourist verification component 620 may be configured as or otherwise support a means for performing an authorized tourist verification in accordance with the local traveler authorization and the federal traveler authorization, wherein the authorized tourist verification may use a secure internal switch and may be associated with a wearable tracking device worn by the tourist.

The output module 608 may manage output signals for the apparatus 602. For example, the output module 608 may receive signals from other components of the apparatus 602, such as the secure tracking component 606, and may transmit these signals to other components or devices. In some specific examples, the output module 608 may transmit output signals for display in a user interface, for storage in a database or data store, for further processing at a server or server cluster, or for any other processes at any number of devices or systems. In some cases, the output module 608 may be a component of an I/O controller 806 as described with reference to FIG. 8.

FIG. 7 shows a block diagram 700 of a secure tracking component 702 that supports a wearable tracking device for real-time monitoring and immigration compliance in accordance with various aspects of the present disclosure. The secure tracking component 702 may be an example of aspects of a secure tracking component 606, a secure tracking component 804, or both, as described herein. The secure tracking component 702, or various components thereof, may be an example of means for performing various aspects of a wearable tracking device for real-time monitoring and immigration compliance as described herein. For example, the secure tracking component 702 may include one or more of a registration message transmission component 704, a location data validation component 706, a validation message authentication component 708, a traveler request processing component 710, a traveler authorization receiving component 712, an authorized tourist verification component 714, a tamper alert transmission component 716, a geofence comparison component 718, a transmission interval adjustment component 720, a cryptographic encryption component 722, a magnetic lock actuation component 724, a wearable device reinforcement component 726, and/or other components. Each of these components may communicate, directly or indirectly, with one another (e.g., via one or more buses).

FIG. 7 presents a functional perspective of the secure tracking component 702 as the secure tracking component 702 operates within the context of a multi-jurisdictional enforcement environment, such as a system deployed for monitoring tourists or temporary visitors.

The secure tracking component 702 is depicted as comprising several integrated modules, each supporting a specific aspect of secure monitoring and compliance enforcement. A registration message transmission component 704 is configured to asynchronously send registration messages containing location tracking data to a local law enforcement server. A location data validation component 706 is responsible for validating received tracking data against locally stored identifying information. A validation message authentication component 708 securely authenticates validation messages sent to a federal law enforcement server.

A traveler request processing component 710 manages confirmed traveler requests, including distress signals or device removal authorizations. A traveler authorization receiving component 712 obtains encrypted local and federal authorizations using public and private cryptographic management systems. An authorized tourist verification component 714 validates compliance with received authorizations via a secure internal switch.

The secure tracking component 702 further includes a tamper alert transmission component 716 for detecting and reporting tampering events, such as interruptions in electrical conductors or disruptions near magnetic locks. A geofence comparison component 718 compares tracking data to predefined enforcement geofences to determine compliance status. A transmission interval adjustment component 720 dynamically modifies reporting intervals based on residual battery capacity to optimize device operation.

A cryptographic encryption component 722 encrypts all personal and location data stored or transmitted by the device. A magnetic lock actuation component 724 controls the actuation of a magnetic lock for authorized device removal. A wearable device reinforcement component 726 provides physical security through steel fiber reinforcement, enhancing resistance to unauthorized removal or damage.

The registration message transmission component 704 is configured to asynchronously send a registration message to a local law enforcement server based on location tracking data of a tourist, where the local law enforcement server may be coupled to a local law enforcement database. In some examples, the registration message may include a serial identification code specifically linked to the wearable tracking device, and may be transmitted via a satellite communication link. The location tracking data may be generated by a GPS-enabled computer chip within the wearable tracking device.

The location data validation component 706 is configured to receive, from the local law enforcement server, locally identifying information associated with the tourist in response to the registration message and to validate the location tracking data based on the locally identifying information. In some examples, the locally identifying information may be received in response to a scan of a barcode affixed to the wearable tracking device using a restricted-access application operated by a local authority. The validation may further comprise comparing the location tracking data to a geofence of authorized travel areas retrieved from the local law enforcement database and generating a compliance status based on the comparison.

The validation message authentication component 708 is configured to asynchronously send a validation message associated with the validated location tracking data to a federal law enforcement server, where the federal law enforcement server may be coupled to a federal law enforcement database. The component may also receive, from the federal law enforcement server, federally identifying information associated with the tourist in response to the validation message and authenticate the validation message based on the federally identifying information. In some examples, authentication may further comprise verifying a digital signature included in the federal traveler authorization using a stored federal public cryptographic identifier.

The traveler request processing component 710 is configured to receive a confirmed traveler request from the tourist and send the confirmed traveler request to the local law enforcement server and the federal law enforcement server. In some examples, receiving the confirmed traveler request from the tourist may comprise detecting two consecutive activations of a panic button on the wearable tracking device.

The traveler authorization receiving component 712 is configured to receive, from the local law enforcement server, a local traveler authorization associated with the confirmed traveler request, where the local traveler authorization may be received via a traveler programmable user interface and may comprise a secure, encrypted Internet Protocol (IP) message using encryption hashed with public and private cryptographic management. The component may also receive, from the federal law enforcement server, a federal traveler authorization associated with the confirmed traveler request, where the federal traveler authorization may be received via the traveler programmable user interface and may comprise a secure, encrypted IP message using encryption hashed with public and private cryptographic management.

The authorized tourist verification component 714 is configured to perform an authorized tourist verification in accordance with the local traveler authorization and the federal traveler authorization, where the authorized tourist verification may use a secure internal switch and may be associated with a wearable tracking device worn by the tourist. In some examples, performing the authorized tourist verification using the secure internal switch may comprise actuating a magnetic lock of the wearable tracking device to permit removal of the wearable tracking device.

The tamper alert transmission component 716 is configured to asynchronously send a tamper alert to at least one of the local law enforcement server and the federal law enforcement server upon detecting an interruption of an electrical tamper-detection conductor within the wearable tracking device. In some examples, the tamper alert may also be generated in response to detecting a magnetic field disruption near the magnetic lock or a predefined pattern of physical impact on the device.

The geofence comparison component 718 is configured to compare the location tracking data to a geofence of authorized travel areas retrieved from the local law enforcement database and generate a compliance status based on the comparison. The component may also transmit a compliance status update to the local law enforcement server in response to detecting entry into or exit from a predefined geofence.

The transmission interval adjustment component 720 is configured to dynamically adjust a transmission interval for asynchronously sending the registration message based on a residual battery capacity of the wearable tracking device. In some examples, the wearable tracking device may be configured to transmit a low-battery alert to the local law enforcement server in response to detecting a battery level below a predefined threshold.

The cryptographic encryption component 722 is configured to encrypt all personal and location data stored within the wearable tracking device using public and private cryptographic management prior to transmitting the data to the local law enforcement server. In some examples, the wearable tracking device may buffer the location tracking data upon loss of network connectivity and transmit the buffered location tracking data upon restoration of connectivity.

The magnetic lock actuation component 724 is configured to control the actuation of a magnetic lock for securing the wearable tracking device to the tourist and for authorized device removal. In some examples, the wearable tracking device may be configured to restrict removal or installation to authorized checkpoints and to deactivate the magnetic lock in response to receiving an authorized removal command from the local law enforcement server.

The wearable device reinforcement component 726 is configured to provide physical security through steel fiber reinforcement, enhancing resistance to deliberate physical damage or unauthorized removal. In some examples, the wearable tracking device may be selected from the group consisting of a wristband, a smart necklace, and a smart ring, and may be reusable to lower overall expenses.

According to various embodiments, this configuration, as shown in FIG. 7, is situated within a broader system environment where the secure tracking component 702 interoperates with local and federal law enforcement infrastructure, supporting secure, reliable, and scalable monitoring of travelers across multiple enforcement domains.

FIG. 8 shows a diagram of a system 800 including a device 802 that supports a wearable tracking device for real-time monitoring and immigration compliance in accordance with aspects of the present disclosure. The device 802 may be an example of or include the components of a database server or an apparatus 602 as described herein. The device 802 may include components for bi-directional data communications, including components for transmitting and receiving communications, including a secure tracking component 804, an I/O controller 806, a database controller 808, memory 810, a processor 812, and a database 814. These components may be in electronic communication via one or more buses (e.g., bus 816).

The secure tracking component 804 may be an example of a secure tracking component 606 or 702 as described herein. For example, the secure tracking component 804 may perform any of the methods or processes described above with reference to FIG. 6 and FIG. 7. In some cases, the secure tracking component 804 may be implemented in hardware, software executed by a processor, firmware, or any combination thereof.

The I/O controller 806 may manage input signals 818 and output signals 820 for the device 802. The I/O controller 806 may also manage peripherals not integrated into the device 802. In some cases, the I/O controller 806 may represent a physical connection or port to an external peripheral. In some cases, the I/O controller 806 may utilize an operating system such as iOS®, ANDROID®, MS-DOS®, MS-WINDOWS®, OS/2®, UNIX®, LINUX®, or another known operating system. In other cases, the I/O controller 806 may represent or interact with a modem, a keyboard, a mouse, a touchscreen, or a similar device. In some cases, the I/O controller 806 may be implemented as part of a processor. In some cases, a user may interact with the device 802 via the I/O controller 806 or via hardware components controlled by the I/O controller 806.

The database controller 808 may manage data storage and processing in a database 814. In some cases, a user may interact with the database controller 808. In other cases, the database controller 808 may operate automatically without user interaction. The database 814 may be an example of a single database, a distributed database, multiple distributed databases, a data store, a data lake, or an emergency backup database.

Memory 810 may include random-access memory (RAM) and read-only memory (ROM). The memory 810 may store computer-readable, computer-executable software including instructions that, when executed, cause the processor to perform various functions described herein. In some cases, the memory 810 may contain, among other things, a basic input/output system (BIOS) which may control basic hardware or software operation, such as the interaction with peripheral components or devices.

The processor 812 may include a hardware device (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, the processor 812 may be configured to operate a memory array using a memory controller. In other cases, a memory controller may be integrated into the processor 812. The processor 812 may be configured to execute computer-readable instructions stored in a memory 810 to perform various functions (e.g., functions or tasks supporting a wearable tracking device for real-time monitoring and immigration compliance).

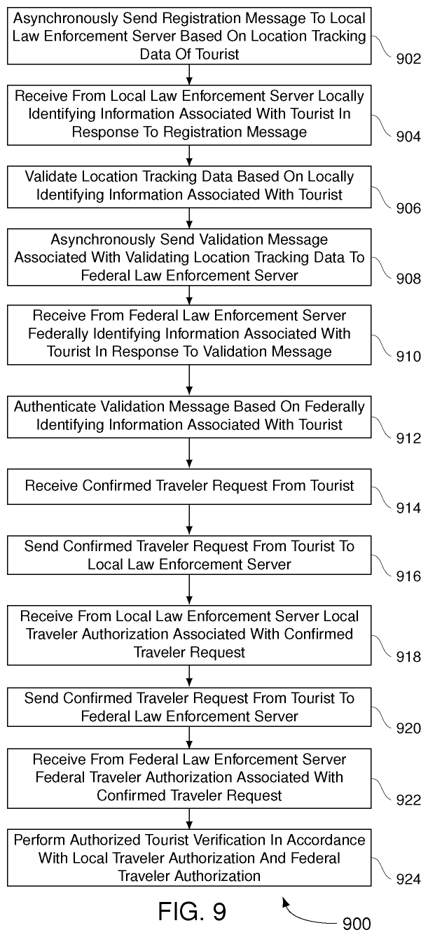

FIG. 9 shows a flowchart illustrating a method 900 that supports a wearable tracking device for real-time monitoring and immigration compliance in accordance with various aspects of the present disclosure. The operations of the method 900 may be implemented by one or more components of a networked computing system as described herein. For example, the operations of the method 900 may be performed by a secure tracking component as described with reference to FIG. 6 through FIG. 8. In some examples, one or more components of a networked computing system may execute a set of instructions to control the functional elements of the component(s) to perform the described functions. Additionally or alternatively, the one or more components of a networked computing system may perform aspects of the described functions using special-purpose hardware.

At 902, the method 900 may include asynchronously sending a registration message to a local law enforcement server, based on location tracking data of a tourist, the local law enforcement server coupled to a local law enforcement database. The operations of 902 may be performed in accordance with examples as disclosed herein. In some examples, aspects of the operations of 902 may be performed by a registration message transmission component 704 as described with reference to FIG. 7.

In one embodiment, the wearable tracking device is configured to asynchronously send a registration message to a local law enforcement server based on the location tracking data of a tourist, with the local law enforcement server coupled to a local law enforcement database for real-time monitoring and recordkeeping. In another embodiment, the registration message may include additional information such as device identification, traveler personal details, and timestamp, enabling comprehensive registration and tracking. The asynchronous transmission may be implemented using various communication channels, including satellite, cellular, or Wi-Fi links, to ensure reliable delivery regardless of the tourist's location. This feature can be incorporated in different wearable formats, such as wristbands, necklaces, or rings, and may be supplemented by encryption protocols to secure the registration message and protect sensitive information. Additionally, the system may log each registration event for audit and compliance purposes, maintaining a robust record of tourist entries and device activations.

At 904, the method 900 may include receiving, from the local law enforcement server, locally identifying information associated with the tourist in response to the registration message. The operations of 904 may be performed in accordance with examples as disclosed herein. In some examples, aspects of the operations of 904 may be performed by a location data validation component 706 as described with reference to FIG. 7.

In one embodiment, the wearable tracking device system receives, from the local law enforcement server, locally identifying information associated with the tourist in response to the registration message, enabling immediate verification and monitoring. In another embodiment, the locally identifying information may include personal details such as name, address, passport number, and travel authorization, which are cross-referenced with the local law enforcement database for accuracy and compliance. The information may be delivered to authorized personnel via secure applications on mobile devices, tablets, or dedicated scanners, and can be used to facilitate rapid identification during routine checks or emergency situations. This feature can be implemented across various wearable formats, such as wristbands, necklaces, or rings, and may be supplemented by audit logging of each information retrieval event for compliance and security review.

At 906, the method 900 may include validating the location tracking data based on the locally identifying information associated with the tourist. The operations of 906 may be performed in accordance with examples as disclosed herein. In some examples, aspects of the operations of 906 may be performed by a location data validation component 706 as described with reference to FIG. 7.

In one embodiment, the wearable tracking device system validates the location tracking data based on the locally identifying information associated with the tourist, ensuring that the tracked movements correspond to the authorized traveler. In another embodiment, the validation process may involve cross-referencing the location tracking data with the tourist's personal details, travel authorization, and permitted travel zones stored in the local law enforcement database. The validation may be performed automatically by the device or by the local law enforcement server, and can trigger compliance status updates or alerts if discrepancies are detected. This feature can be implemented in various wearable formats, such as wristbands, necklaces, or rings, and may be supplemented by audit logging of each validation event for compliance and security review.

At 908, the method 900 may include asynchronously sending a validation message associated with the validating the location tracking data to a federal law enforcement server, the federal law enforcement server coupled to a federal law enforcement database. The operations of 908 may be performed in accordance with examples as disclosed herein. In some examples, aspects of the operations of 908 may be performed by a validation message authentication component 708 as described with reference to FIG. 7.

In one embodiment, the wearable tracking device system asynchronously sends a validation message associated with validating the location tracking data to a federal law enforcement server, with the federal law enforcement server coupled to a federal law enforcement database for centralized monitoring and recordkeeping. In another embodiment, the validation message may include details such as device identification, traveler personal information, validated location data, and timestamp, enabling comprehensive verification at the federal level. The asynchronous transmission may utilize secure communication channels, including satellite, cellular, or Wi-Fi links, to ensure reliable delivery regardless of the tourist's location. This feature can be implemented in various wearable formats, such as wristbands, necklaces, or rings, and may be supplemented by encryption protocols to protect sensitive information during transmission. Additionally, the system may log each validation message event for audit and compliance purposes, maintaining a robust record of traveler movements and device activity.

At 910, the method 900 may include receiving, from the federal law enforcement server, federally identifying information associated with the tourist in response to the validation message. The operations of 910 may be performed in accordance with examples as disclosed herein. In some examples, aspects of the operations of 910 may be performed by a validation message authentication component 708 as described with reference to FIG. 7.

In one embodiment, the wearable tracking device system receives, from the federal law enforcement server, federally identifying information associated with the tourist in response to the validation message, enabling cross-jurisdictional verification and monitoring. In another embodiment, the federally identifying information may include details such as name, passport number, visa status, and travel authorization, which are referenced against the federal law enforcement database for accuracy and compliance. The information may be delivered to authorized personnel via secure applications or integrated directly into the wearable device for automated compliance checks. This feature can be implemented across various wearable formats, such as wristbands, necklaces, or rings, and may be supplemented by audit logging of each information retrieval event for compliance and security review.

At 912, the method 900 may include authenticating the validation message based on the federally identifying information associated with the tourist. The operations of 912 may be performed in accordance with examples as disclosed herein. In some examples, aspects of the operations of 912 may be performed by a validation message authentication component 708 as described with reference to FIG. 7.

In one embodiment, the wearable tracking device system authenticates the validation message based on the federally identifying information associated with the tourist, ensuring that the location tracking data and traveler identity are verified at the federal level. In another embodiment, the authentication process may involve matching the validation message contents with the federally identifying information, such as passport number, visa status, and travel authorization, stored in the federal law enforcement database. The authentication may be performed automatically by the federal law enforcement server or by the wearable device, and can trigger compliance status updates or alerts if discrepancies are detected. This feature can be implemented in various wearable formats, such as wristbands, necklaces, or rings, and may be supplemented by audit logging of each authentication event for compliance and security review.

At 914, the method 900 may include receiving a confirmed traveler request from the tourist. The operations of 914 may be performed in accordance with examples as disclosed herein. In some examples, aspects of the operations of 914 may be performed by a traveler request processing component 710 as described with reference to FIG. 7.

In one embodiment, the wearable tracking device system receives a confirmed traveler request from the tourist, which may be initiated through an interface on the device, such as a button or touchscreen. In another embodiment, the confirmed traveler request can be triggered by a specific sequence of actions, such as pressing the panic button multiple times or scanning a barcode, to ensure intentional submission. The request may include traveler identification, device serial number, and current location, and can be transmitted via secure communication channels to the local law enforcement server for processing. This feature can be implemented in various wearable formats, such as wristbands, necklaces, or rings, and may be supplemented by visual or audio indicators to confirm receipt of the request to the tourist. Additionally, the system may log each confirmed traveler request for audit and compliance purposes.

At 916, the method 900 may include sending the confirmed traveler request from the tourist to the local law enforcement server. The operations of 916 may be performed in accordance with examples as disclosed herein. In some examples, aspects of the operations of 916 may be performed by a traveler request processing component 710 as described with reference to FIG. 7.

In one embodiment, the wearable tracking device system sends the confirmed traveler request from the tourist to the local law enforcement server, enabling prompt review and processing by authorized personnel. In another embodiment, the confirmed traveler request is transmitted via secure communication channels, such as satellite, cellular, or Wi-Fi links, to ensure reliable delivery regardless of the tourist's location. The request may include relevant information such as traveler identification, device serial number, and current location, and can be implemented in various wearable formats, including wristbands, necklaces, or rings. Additionally, the system may log each transmission event for audit and compliance purposes, maintaining a robust record of traveler requests and device activity.

At 918, the method 900 may include receiving, from the local law enforcement server, a local traveler authorization associated with the confirmed traveler request, the local traveler authorization being received via a traveler programmable user interface, the local traveler authorization comprising: a secure, encrypted, Internet Protocol (IP) message using encryption hashed with public and private key management. The operations of 918 may be performed in accordance with examples as disclosed herein. In some examples, aspects of the operations of 918 may be performed by a traveler authorization receiving component 712 as described with reference to FIG. 7.

In one embodiment, the wearable tracking device system receives, from the local law enforcement server, a local traveler authorization associated with the confirmed traveler request, with the authorization delivered via a traveler programmable user interface. In another embodiment, the local traveler authorization is provided as a secure, encrypted Internet Protocol (IP) message, utilizing encryption hashed with public and private cryptographic management to ensure the confidentiality and integrity of the authorization data. The traveler programmable user interface may be implemented on the wearable device itself or through a connected mobile application, allowing the traveler to interact with and receive authorization updates. This feature can be incorporated in various wearable formats, such as wristbands, necklaces, or rings, and may be supplemented by audit logging of each authorization event for compliance and security review.

In another embodiment, the local traveler authorization is provided as a secure, encrypted Internet Protocol (IP) message, utilizing encryption hashed with public and private cryptographic management to ensure the confidentiality and integrity of the authorization data. For example, the local law enforcement server generates a traveler authorization message containing the traveler's identification and device serial number, encrypts the message using the server's private cryptographic credential and the wearable device's public cryptographic credential, and transmits the encrypted IP message to the wearable device. Upon receipt, the wearable device decrypts the message using the wearable device's private cryptographic credential and verifies the server's digital signature with the server's public cryptographic credential, thereby confirming the authenticity and integrity of the authorization before permitting further actions, such as device removal or compliance updates.

At 920, the method 900 may include sending the confirmed traveler request from the tourist to the federal law enforcement server. The operations of 920 may be performed in accordance with examples as disclosed herein. In some examples, aspects of the operations of 920 may be performed by a traveler request processing component 710 as described with reference to FIG. 7.

In one embodiment, the wearable tracking device system sends the confirmed traveler request from the tourist to the federal law enforcement server, enabling centralized review and processing by federal authorities. In another embodiment, the confirmed traveler request is transmitted via secure communication channels, such as satellite, cellular, or Wi-Fi links, to ensure reliable delivery regardless of the tourist's location. The request may include relevant information such as traveler identification, device serial number, and current location, and can be implemented in various wearable formats, including wristbands, necklaces, or rings. Additionally, the system may log each transmission event for audit and compliance purposes, maintaining a robust record of traveler requests and device activity at the federal level.

At 922, the method 900 may include receiving, from the federal law enforcement server, a federal traveler authorization associated with the confirmed traveler request, the federal traveler authorization being received via the traveler programmable user interface, the federal traveler authorization comprising: a secure, encrypted, Internet Protocol (IP) message using encryption hashed with public and private key management. The operations of 922 may be performed in accordance with examples as disclosed herein. In some examples, aspects of the operations of 922 may be performed by a traveler authorization receiving component 712 as described with reference to FIG. 7.

In one embodiment, the wearable tracking device system receives, from the federal law enforcement server, a federal traveler authorization associated with the confirmed traveler request, with the authorization delivered via the traveler programmable user interface. In another embodiment, the federal traveler authorization is provided as a secure, encrypted Internet Protocol (IP) message, utilizing encryption hashed with public and private cryptographic management to ensure the confidentiality and integrity of the authorization data. For example, the federal law enforcement server generates a traveler authorization message containing the traveler's identification and device serial number, encrypts the message using the server's private cryptographic credential and the wearable device's public cryptographic credential, and transmits the encrypted IP message to the wearable device. Upon receipt, the wearable device decrypts the message using the wearable device's private cryptographic credential and verifies the server's digital signature with the server's public cryptographic credential, thereby confirming the authenticity and integrity of the federal traveler authorization before permitting further actions, such as device removal or compliance updates. The traveler programmable user interface may be implemented on the wearable device or through a connected mobile application, allowing the traveler to interact with and receive authorization updates. This feature can be incorporated in various wearable formats, such as wristbands, necklaces, or rings, and may be supplemented by audit logging of each authorization event for compliance and security review.

At 924, the method 900 may include performing an authorized tourist verification in accordance with the local traveler authorization and the federal traveler authorization, the performing of the authorized tourist verification using a secure internal switch and being associated with a wearable tracking device worn by a tourist. The operations of 924 may be performed in accordance with examples as disclosed herein. In some examples, aspects of the operations of 924 may be performed by an authorized tourist verification component 714 as described with reference to FIG. 7.

In one embodiment, the wearable tracking device system performs an authorized tourist verification in accordance with the local traveler authorization and the federal traveler authorization, utilizing a secure internal switch integrated within the device. In another embodiment, the secure internal switch is configured to actuate only upon successful receipt and validation of both local and federal traveler authorizations, thereby ensuring that removal or modification of the device is permitted solely for authorized tourists. The verification process may include cross-referencing the traveler's identification and device serial number with the authorizations received, and logging each verification event for compliance and audit purposes. This feature can be implemented in various wearable formats, such as wristbands, necklaces, or rings, and may be supplemented by additional security mechanisms, such as cryptographic authentication and tamper detection, to further enhance the integrity of the verification process.

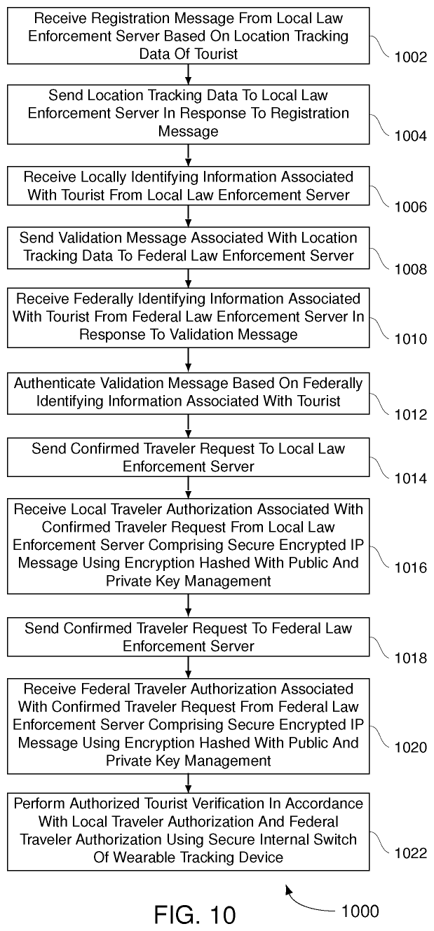

FIG. 10 shows a flowchart illustrating a method 1000 that supports a wearable tracking device for real-time monitoring and immigration compliance in accordance with various aspects of the present disclosure. The operations of the method 1000 may be implemented by one or more components of a networked computing system as described herein. For example, the operations of the method 1000 may be performed by a secure tracking component as described with reference to FIG. 6, FIG. 7, and FIG. 8. In some examples, one or more components of a networked computing system may execute a set of instructions to control the functional elements of the component(s) to perform the described functions. Additionally or alternatively, the one or more components of a networked computing system may perform aspects of the described functions using special-purpose hardware.

At 1002, the method 1000 may include receiving, at a wearable tracking device worn by a tourist, a registration message from a local law enforcement server, the registration message being based on location tracking data of the tourist, and the local law enforcement server is coupled to a local law enforcement database. The operations of 1002 may be performed in accordance with examples as disclosed herein. In some examples, aspects of the operations of 1002 may be performed by a registration message transmission component 704 as described with reference to FIG. 7.

At 1004, the method 1000 may include sending, from the wearable tracking device, location tracking data to the local law enforcement server in response to the registration message. The operations of 1004 may be performed in accordance with examples as disclosed herein. In some examples, aspects of the operations of 1004 may be performed by a location data validation component 706 as described with reference to FIG. 7.

At 1006, the method 1000 may include receiving, at the wearable tracking device, locally identifying information associated with the tourist from the local law enforcement server. The operations of 1006 may be performed in accordance with examples as disclosed herein. In some examples, aspects of the operations of 1006 may be performed by a traveler authorization receiving component 712 as described with reference to FIG. 7.

At 1008, the method 1000 may include sending, from the wearable tracking device, a validation message associated with the location tracking data to a federal law enforcement server, the federal law enforcement server being coupled to a federal law enforcement database. The operations of 1008 may be performed in accordance with examples as disclosed herein. In some examples, aspects of the operations of 1008 may be performed by a validation message authentication component 708 as described with reference to FIG. 7.

At 1010, the method 1000 may include receiving, at the wearable tracking device, federally identifying information associated with the tourist from the federal law enforcement server in response to the validation message. The operations of 1010 may be performed in accordance with examples as disclosed herein. In some examples, aspects of the operations of 1010 may be performed by a traveler authorization receiving component 712 as described with reference to FIG. 7.

At 1012, the method 1000 may include authenticating, at the wearable tracking device, the validation message based on the federally identifying information associated with the tourist. The operations of 1012 may be performed in accordance with examples as disclosed herein. In some examples, aspects of the operations of 1012 may be performed by a validation message authentication component 708 as described with reference to FIG. 7.

At 1014, the method 1000 may include sending, from the wearable tracking device, a confirmed traveler request to the local law enforcement server. The operations of 1014 may be performed in accordance with examples as disclosed herein. In some examples, aspects of the operations of 1014 may be performed by a traveler request processing component 710 as described with reference to FIG. 7.

At 1016, the method 1000 may include receiving, at the wearable tracking device, a local traveler authorization associated with the confirmed traveler request from the local law enforcement server, the local traveler authorization comprising: a secure, encrypted Internet Protocol (IP) message using encryption hashed with public and private key management. The operations of 1016 may be performed in accordance with examples as disclosed herein. In some examples, aspects of the operations of 1016 may be performed by a cryptographic encryption component 722 as described with reference to FIG. 7.

At 1018, the method 1000 may include sending, from the wearable tracking device, the confirmed traveler request to the federal law enforcement server. The operations of 1018 may be performed in accordance with examples as disclosed herein. In some examples, aspects of the operations of 1018 may be performed by a traveler request processing component 710 as described with reference to FIG. 7.

At 1020, the method 1000 may include receiving, at the wearable tracking device, a federal traveler authorization associated with the confirmed traveler request from the federal law enforcement server, the federal traveler authorization comprising: a secure, encrypted Internet Protocol (IP) message using encryption hashed with public and private key management. The operations of 1020 may be performed in accordance with examples as disclosed herein. In some examples, aspects of the operations of 1020 may be performed by a cryptographic encryption component 722 as described with reference to FIG. 7.

At 1022, the method 1000 may include performing, at the wearable tracking device, an authorized tourist verification in accordance with the local traveler authorization and the federal traveler authorization, the performing of the authorized tourist verification using a secure internal switch of the wearable tracking device. The operations of 1022 may be performed in accordance with examples as disclosed herein. In some examples, aspects of the operations of 1022 may be performed by an authorized tourist verification component 714 as described with reference to FIG. 7.

It should be noted that the methods described herein describe possible implementations, and that the operations and the steps may be rearranged or otherwise modified, and that other implementations are possible. Furthermore, aspects from two or more of the methods may be combined.

For purposes of this disclosure of the present technology, the following terms shall have the meanings set forth below unless the context clearly indicates otherwise.

As used herein, “asynchronous messaging” refers to a communication method that allows data to be transmitted intermittently without requiring a continuous connection, enabling the wearable tracking device to send updates even during temporary network outages.

As used herein, “barcode” refers to a machine-readable code affixed to the wearable tracking device, containing basic traveler information such as name, address, passport number, and date of exit, accessible via a restricted-access application.

As used herein, “compliance status” refers to a determination of whether a traveler is adhering to authorized travel areas or immigration regulations, often based on geofence comparisons.

As used herein, “confirmed traveler request” refers to a user-initiated action, such as distress signaling or device removal authorization, transmitted to law enforcement servers for processing.

As used herein, “cryptographic encryption” refers to the process of securing data using public and private cryptographic key management to protect sensitive personal and location information during storage and transmission.

As used herein, “device integrity status” refers to a report indicating the operational condition of the wearable tracking device, including tamper detection and battery level.

As used herein, “electric wire” refers to a component within the wearable tracking device that acts as a tamper-detection conductor, triggering alerts upon interruption or removal.

As used herein, “federal traveler authorization” refers to a secure, encrypted message issued by a federal law enforcement server, confirming the traveler's compliance with immigration regulations.

As used herein, “geofence” refers to a virtual boundary defining authorized travel areas, used to monitor and enforce compliance by comparing location tracking data.

As used herein, “GPS-enabled computer chip” refers to a component within the wearable tracking device that generates real-time location tracking data, enabling continuous monitoring of the traveler's movements.

As used herein, “local traveler authorization” refers to a secure, encrypted message issued by a local law enforcement server, validating the traveler's compliance with local regulations.

As used herein, “magnetic lock” refers to a security mechanism integrated into the wearable tracking device, ensuring the device can only be removed or installed at authorized checkpoints.

As used herein, “panic button” refers to a user-activated feature on the wearable tracking device that sends a distress signal to law enforcement servers, requiring two consecutive activations to minimize accidental triggers.

As used herein, “registration message” refers to a data packet sent asynchronously to a local law enforcement server, containing location tracking data and device identification information.

As used herein, “satellite communication link” refers to a communication channel enabling data transmission between the wearable tracking device and law enforcement servers, particularly in areas without cellular or Wi-Fi coverage.

As used herein, “secure internal switch” refers to a tamper-resistant mechanism within the wearable tracking device that consumes cryptographically protected authorizations to control device states, such as reporting modes and authorized removal.

As used herein, “steel fiber reinforcement” refers to a durable material integrated into the wearable tracking device to prevent deliberate physical damage or unauthorized removal.

As used herein, “tamper alert” refers to a notification sent to law enforcement servers upon detecting an interruption in the tamper-detection conductor, magnetic field disruption, or predefined impact patterns.

As used herein, “traveler programmable user interface” refers to a user-accessible interface on the wearable tracking device, allowing travelers to initiate requests such as distress signals or device removal authorizations.

As used herein, “validation message” refers to a data packet sent asynchronously to a federal law enforcement server, confirming the authenticity of location tracking data validated by local law enforcement.

As used herein, “wearable tracking device” refers to a smart device, such as a wristband, necklace, or ring, equipped with components for real-time monitoring, compliance enforcement, and secure data transmission.

Aspect 1: A secure tracking method of verifying movement of tourists for real-time monitoring, the secure tracking method comprising: asynchronously sending a registration message to a local law enforcement server, based on location tracking data of a tourist, the local law enforcement server coupled to a local law enforcement database; receiving, from the local law enforcement server, locally identifying information associated with the tourist in response to the registration message; validating the location tracking data based on the locally identifying information associated with the tourist; asynchronously sending a validation message associated with the validating the location tracking data to a federal law enforcement server, the federal law enforcement server coupled to a federal law enforcement database; receiving, from the federal law enforcement server, federally identifying information associated with the tourist in response to the validation message; authenticating the validation message based on the federally identifying information associated with the tourist; receiving a confirmed traveler request from the tourist; sending the confirmed traveler request from the tourist to the local law enforcement server; receiving, from the local law enforcement server, a local traveler authorization associated with the confirmed traveler request, the local traveler authorization being received via a traveler programmable user interface, the local traveler authorization comprising: a secure, encrypted, Internet Protocol (IP) message using encryption hashed with public and private key management; sending the confirmed traveler request from the tourist to the federal law enforcement server; receiving, from the federal law enforcement server, a federal traveler authorization associated with the confirmed traveler request, the federal traveler authorization being received via the traveler programmable user interface, the federal traveler authorization comprising: a secure, encrypted, Internet Protocol (IP) message using encryption hashed with public and private key management; and performing an authorized tourist verification in accordance with the local traveler authorization and the federal traveler authorization, the performing of the authorized tourist verification using a secure internal switch and being associated with a wearable tracking device worn by a tourist.

Aspect 2: The method of aspect 1, wherein the location tracking data is generated by a GPS-enabled computer chip within the wearable tracking device. In one embodiment, the GPS-enabled computer chip within the wearable tracking device is designed to operate using satellite communication, ensuring continuous location tracking even in remote areas without cellular or Wi-Fi coverage. This chip may be configured to transmit location data at adjustable intervals based on battery capacity, optimizing power consumption for extended use. In another embodiment, the GPS-enabled chip is integrated with a geofencing feature, allowing the device to alert authorities if the tourist moves outside predefined travel zones. The chip may also include a buffering mechanism to store location data temporarily during network interruptions, transmitting the stored data once connectivity is restored. Additionally, the GPS-enabled chip can be implemented in various wearable formats, such as wristbands, necklaces, or rings, to accommodate different user preferences and comfort levels. The chip may be constructed using durable materials to withstand environmental conditions, such as water resistance for outdoor activities or a reinforced casing to prevent tampering. Furthermore, the GPS-enabled chip could be paired with encryption protocols to secure the transmission of location data, ensuring compliance with privacy regulations and safeguarding sensitive information.

Aspect 3: The method of any of aspects 1 through 2, wherein receiving the locally identifying information comprises receiving the locally identifying information in response to a scan of a barcode affixed to the wearable tracking device using a restricted-access application operated by a local authority. In one embodiment, locally identifying information is received in response to scanning a barcode affixed to the wearable tracking device using a restricted-access application operated by a local authority, where the barcode encodes personal details such as name, address, passport number, and date of exit. In another embodiment, the barcode is optional and may be replaced or supplemented by a serial identification code printed or embedded on the device, which is scanned by a secure application to retrieve locally identifying information. The restricted-access application may be implemented on a mobile device, tablet, or dedicated scanner, and can be configured to require authentication by law enforcement personnel before accessing the encoded information. In yet another embodiment, the wearable tracking device may include a QR code or other machine-readable identifier, which is scanned by the restricted-access application to cross-reference the traveler's information with local law enforcement databases, thereby facilitating rapid identification and compliance verification. The barcode or identifier may be printed, etched, or embedded in the device casing, and may be constructed from materials resistant to tampering or environmental damage, ensuring reliable operation throughout the traveler's visit.

Aspect 4: The method of any of aspects 1 through 3, further comprising, upon detecting an interruption of an electrical tamper-detection conductor within the wearable tracking device, asynchronously sending a tamper alert to at least one of the local law enforcement server and the federal law enforcement server. In one embodiment, the wearable tracking device includes an electrical tamper-detection conductor that, upon interruption, triggers an asynchronous tamper alert sent to at least one of the local law enforcement server and the federal law enforcement server. In another embodiment, the tamper-detection conductor is integrated as a continuous wire within the device's band or casing, and any break or cut in the wire immediately initiates a tamper alert transmission. The tamper alert may be transmitted via multiple communication channels, including satellite or cellular links, to ensure delivery even in areas with limited connectivity. In yet another embodiment, the tamper-detection mechanism is supplemented by additional sensors, such as magnetic field disruption detectors or impact sensors, which can also trigger tamper alerts if unauthorized removal or physical damage is detected. The tamper alert may include device identification, timestamp, and location data to assist authorities in rapid response and investigation. The tamper-detection conductor and associated alert system may be implemented in various wearable formats, such as wristbands, necklaces, or rings, and constructed from materials designed to resist accidental breakage while reliably detecting intentional tampering.

Aspect 5: The method of any of aspects 1 through 4, wherein receiving the confirmed traveler request from the tourist comprises detecting two consecutive activations of a panic button on the wearable tracking device. In one embodiment, the wearable tracking device is equipped with a panic button that, when pressed twice consecutively, is detected as a confirmed traveler request and triggers an alert to enforcement authorities. In another embodiment, the panic button is designed with a timing mechanism that requires two activations within a predefined interval to distinguish intentional distress signals from accidental presses. The panic button may be implemented in various wearable formats, such as wristbands, necklaces, or rings, and can be constructed with tactile feedback to ensure the user is aware of each activation. In yet another embodiment, the panic button is supplemented by a visual or audio indicator that confirms to the traveler that the request has been registered, thereby reducing uncertainty during emergency situations. The system may also log the sequence and timing of activations for audit and compliance purposes, and the panic button can be integrated with additional sensors to further validate the authenticity of the distress signal.

Aspect 6: The method of any of aspects 1 through 5, wherein asynchronously sending at least one of the registration message or the validation message is performed via a satellite communication link. In one embodiment, the wearable tracking device is configured to asynchronously send at least one of the registration message or the validation message via a satellite communication link, enabling reliable data transmission even in areas without cellular or Wi-Fi coverage. In another embodiment, the device may utilize a hybrid communication system, automatically switching between satellite, cellular, and Wi-Fi links based on available connectivity to optimize transmission efficiency and reduce operational costs. The satellite communication link may be implemented using a dedicated module integrated within the wearable device, ensuring secure and encrypted transmission of sensitive location and personal data. In yet another embodiment, the satellite communication capability is designed to operate in conjunction with power management features, such as adaptive transmission intervals based on battery capacity, to extend device longevity during prolonged travel. The satellite communication link may also support real-time alerts, such as tamper or distress signals, ensuring prompt notification to enforcement authorities regardless of the traveler's location.

Aspect 7: The method of any of aspects 1 through 6, further comprising buffering the location tracking data within the wearable tracking device upon loss of network connectivity, and transmitting the buffered location tracking data upon restoration of connectivity. In one embodiment, the wearable tracking device is configured to buffer location tracking data within the internal memory of the device upon loss of network connectivity, and to transmit the buffered location tracking data upon restoration of connectivity. In another embodiment, the device may employ a tiered storage system, temporarily storing data in volatile memory for short outages and transferring the data to non-volatile memory for extended periods without connectivity, thereby preserving data integrity. The buffering mechanism may be implemented in various wearable formats, such as wristbands, necklaces, or rings, and can be designed to store data for a predefined duration based on available memory capacity. In yet another embodiment, the device may include a notification feature that alerts the user or enforcement authorities when data transmission resumes, ensuring transparency and accountability in compliance monitoring. The buffered data may be encrypted using public and private cryptographic key management to safeguard sensitive information during storage and transmission.

Aspect 8: The method of any of aspects 1 through 7, wherein validating the location tracking data comprises comparing the location tracking data to a geofence of authorized travel areas retrieved from the local law enforcement database. In one embodiment, validating the location tracking data involves comparing the data to a geofence of authorized travel areas retrieved from the local law enforcement database, enabling the system to determine whether the tourist remains within permitted zones. In another embodiment, the geofence comparison is performed in real time by the wearable tracking device, which can generate compliance status updates and transmit them to enforcement authorities upon detecting entry into or exit from a predefined geofence. The geofence parameters may be dynamically updated based on changes in travel authorization or local regulations, and the comparison process can be implemented in various wearable formats, such as wristbands, necklaces, or rings. Additionally, the geofence boundaries may be stored locally on the device to allow for compliance determination even during temporary network outages, with results transmitted once connectivity is restored. The geofence comparison may also be supplemented by additional criteria, such as time-based restrictions or event-driven triggers, to enhance the accuracy and responsiveness of compliance monitoring.

Aspect 9: The method of any of aspects 1 through 8, wherein performing the authorized tourist verification using the secure internal switch comprises actuating a magnetic lock of the wearable tracking device to permit removal of the wearable tracking device. In one embodiment, performing the authorized tourist verification using the secure internal switch comprises actuating a magnetic lock of the wearable tracking device to permit removal of the wearable tracking device. In another embodiment, the secure internal switch may be configured to require receipt and verification of both local and federal traveler authorizations before actuating the magnetic lock, thereby preventing unauthorized removal. The magnetic lock actuation can be implemented in various wearable formats, such as wristbands, necklaces, or rings, and may utilize different locking mechanisms, including electromagnetic, mechanical, or hybrid systems, to enhance security and durability. Additionally, the secure internal switch may log each actuation event, including timestamp and authorization details, to provide an audit trail for compliance verification and enforcement actions. The magnetic lock may also be designed to restrict removal or installation to authorized checkpoints, such as airports or designated government facilities, further ensuring adherence to immigration protocols.

Aspect 10: The method of any of aspects 1 through 9, further comprising dynamically adjusting a transmission interval for asynchronously sending the registration message based on a residual battery capacity of the wearable tracking device. In one embodiment, the wearable tracking device is configured to dynamically adjust the transmission interval for asynchronously sending the registration message based on the residual battery capacity, thereby optimizing power consumption and extending device operation during a traveler's visit. In another embodiment, the device may employ a multi-level power management system that reduces transmission frequency as battery levels decrease, while maintaining necessary reporting for compliance monitoring. The transmission interval adjustment can be implemented in various wearable formats, such as wristbands, necklaces, or rings, and may be supplemented by a low-battery alert feature that notifies enforcement authorities when battery levels fall below a predefined threshold. Additionally, the device may allow for manual override of transmission intervals in emergency situations or upon receiving specific commands from authorized personnel, ensuring flexibility and reliability in diverse operational environments.

Aspect 11: The method of any of aspects 1 through 10, wherein performing the authorized tourist verification further comprises verifying a digital signature included in the federal traveler authorization using a stored federal public cryptographic identifier. In one embodiment, performing the authorized tourist verification further comprises verifying a digital signature included in the federal traveler authorization using a stored federal public cryptographic identifier. In another embodiment, the wearable tracking device is equipped with a cryptographic module that stores multiple public identifiers, allowing for verification of digital signatures from various enforcement authorities. The verification process may be implemented in real time within the device, ensuring that only properly authenticated federal traveler authorizations trigger subsequent actions, such as device removal or state changes. Additionally, the cryptographic module may support periodic updates of public identifiers to maintain compatibility with evolving security standards and enforcement protocols. The digital signature verification can be applied across different wearable formats, including wristbands, necklaces, or rings, and may be supplemented by audit logging of each verification event for compliance and security review.

Aspect 12: The method of any of aspects 1 through 11, wherein the wearable tracking device comprises a steel fiber reinforcement to prevent deliberate physical damage or unauthorized removal. In one embodiment, the wearable tracking device comprises a steel fiber reinforcement integrated throughout the band or casing to prevent deliberate physical damage or unauthorized removal. In another embodiment, the steel fiber is configured as a continuous loop within the wearable device, making the device resistant to cutting or tearing with common tools. The steel fiber reinforcement may be implemented in various wearable formats, such as wristbands, necklaces, or rings, and can be combined with other materials, such as durable polymers or water-resistant coatings, to enhance overall device strength and longevity. Additionally, the steel fiber may serve as part of the tamper-detection system, triggering alerts if the fiber is broken or compromised, thereby providing both structural integrity and security monitoring.

Aspect 13: The method of any of aspects 1 through 12, wherein the wearable tracking device is selected from the group consisting of a wristband, a smart necklace, and a smart ring. In one embodiment, the wearable tracking device is implemented as a wristband, providing a secure and adjustable fit for the tourist and integrating all required components, such as the GPS-enabled chip, barcode, panic button, steel fiber reinforcement, and magnetic lock. In another embodiment, the wearable tracking device is configured as a smart necklace, designed to be worn comfortably around the neck and incorporating the same tracking and security features as the wristband. In yet another embodiment, the wearable tracking device is realized as a smart ring, offering a discreet and compact form factor while maintaining the functionalities necessary for real-time monitoring and compliance enforcement. Each format may be selected based on user preference, comfort, or operational requirements, and all are designed to ensure interoperability with law enforcement systems and durability against tampering or environmental exposure.

Aspect 14: The method of any of aspects 1 through 13, wherein the registration message includes a serial identification code specifically linked to the wearable tracking device. In one embodiment, the registration message includes a serial identification code specifically linked to the wearable tracking device, enabling authorities to identify and track each device throughout its operational lifecycle. In another embodiment, the serial identification code is embedded within the device's firmware and transmitted automatically with each registration message, ensuring consistent association between the device and the traveler. The serial identification code may be printed, etched, or encoded on the device casing, and can be supplemented by additional identifiers, such as barcodes or QR codes, for enhanced traceability. The serial identification code system may be implemented across various wearable formats, including wristbands, necklaces, or rings, and can be designed to support device reassignment and reuse by updating the code in the system database upon activation for a new traveler.

Aspect 15: The method of any of aspects 1 through 14, further comprising encrypting all personal and location data stored within the wearable tracking device using public and private cryptographic management. In one embodiment, all personal and location data stored within the wearable tracking device is encrypted using public and private cryptographic management, ensuring that sensitive information is protected from unauthorized access. In another embodiment, the encryption process is performed automatically by an integrated cryptographic module within the device, which applies advanced encryption algorithms to both stored and transmitted data. The encryption protocols may be periodically updated to comply with evolving security standards and regulatory requirements. The encrypted data may be accessible only to authorized law enforcement personnel through secure authentication procedures, and the encryption system can be implemented across various wearable formats, such as wristbands, necklaces, or rings. Additionally, the device may support multi-layer encryption, combining symmetric and asymmetric cryptographic management to further enhance data security and privacy.

Aspect 16: The method of any of aspects 1 through 15, wherein the wearable tracking device is configured to restrict removal or installation to authorized checkpoints. In one embodiment, the wearable tracking device is configured to restrict removal or installation to authorized checkpoints, such as airports or designated government facilities, thereby preventing unauthorized access or tampering. In another embodiment, the device incorporates a locking mechanism that can only be actuated by authorized personnel using specialized tools or cryptographically protected commands, ensuring that the device remains securely attached to the tourist throughout their visit. The restriction mechanism may be implemented in various wearable formats, including wristbands, necklaces, or rings, and can be supplemented by audit logging of each installation or removal event for compliance verification. Additionally, the device may include sensors that detect attempts to remove or install the device outside of authorized locations, triggering alerts to enforcement authorities and maintaining the integrity of the monitoring system.

Aspect 17: The method of any of aspects 1 through 16, further comprising comparing the location tracking data to a geofence of authorized travel areas retrieved from the local law enforcement database and generating a compliance status based on the comparison. In one embodiment, the wearable tracking device compares the location tracking data to a geofence of authorized travel areas retrieved from the local law enforcement database and generates a compliance status based on the comparison. In another embodiment, the geofence comparison is performed locally on the device, allowing for immediate compliance determination even during temporary network outages, with compliance status updates transmitted once connectivity is restored. The geofence parameters may be dynamically updated based on changes in travel authorization or local regulations, and the compliance status may trigger alerts or notifications to enforcement authorities if a tourist enters or exits a predefined geofence. The geofence comparison and compliance status generation can be implemented in various wearable formats, such as wristbands, necklaces, or rings, and may be supplemented by additional criteria, such as time-based restrictions or event-driven triggers, to enhance the accuracy and responsiveness of compliance monitoring.

Aspect 18: The method of any of aspects 1 through 17, further comprising encrypting the location tracking data and personal information stored within the wearable tracking device using public and private cryptographic key management prior to transmitting the data to the local law enforcement server. In one embodiment, the wearable tracking device encrypts the location tracking data and personal information stored within the device using public and private cryptographic key management prior to transmitting the data to the local law enforcement server. In another embodiment, the encryption process is performed by a dedicated cryptographic module integrated within the wearable device, applying advanced encryption algorithms to both location and personal data. The encrypted data may be transmitted over secure communication channels, such as satellite or cellular links, to maintain confidentiality and integrity during transfer. The encryption protocols can be periodically updated to comply with evolving security standards and regulatory requirements, and the system may support multi-layer encryption for enhanced protection. This encryption feature may be implemented across various wearable formats, including wristbands, necklaces, or rings, and ensures that only authorized law enforcement personnel can access the transmitted data through secure authentication procedures.

Aspect 19: The method of any of aspects 1 through 18, wherein the wearable tracking device includes a panic button configured to transmit a distress signal to the local law enforcement server in response to three consecutive activations within a predefined time period. In one embodiment, the wearable tracking device includes a panic button configured to transmit a distress signal to the local law enforcement server in response to three consecutive activations within a predefined time period, thereby distinguishing intentional emergency requests from accidental presses. In another embodiment, the panic button is designed with a timing mechanism that requires three activations within a set interval, ensuring that only deliberate distress signals are transmitted. The panic button may be implemented in various wearable formats, such as wristbands, necklaces, or rings, and can be constructed with tactile feedback or visual indicators to confirm activation. Additionally, the system may log the sequence and timing of activations for audit and compliance purposes, and the panic button can be integrated with additional sensors to further validate the authenticity of the distress signal before alerting enforcement authorities.

Aspect 20: The method of any of aspects 1 through 19, wherein the wearable tracking device is configured to transmit a low-battery alert to the local law enforcement server in response to detecting a battery level below a predefined threshold. In one embodiment, the wearable tracking device is configured to transmit a low-battery alert to the local law enforcement server in response to detecting a battery level below a predefined threshold, enabling authorities to proactively address potential device downtime. In another embodiment, the device may include a multi-stage alert system that sends initial warnings at higher battery thresholds and escalates notifications as the battery approaches lower levels. The low-battery alert feature can be implemented in various wearable formats, such as wristbands, necklaces, or rings, and may be supplemented by visual or audio indicators to inform the user of the battery status. Additionally, the device may allow for remote adjustment of reporting intervals or activation of power-saving modes upon detection of low battery, ensuring continued compliance monitoring until the device can be recharged or replaced.

Aspect 21: The method of any of aspects 1 through 20, wherein the wearable tracking device is configured to store location tracking data for a predefined duration in response to a loss of communication with the local law enforcement server. In one embodiment, the wearable tracking device is configured to store location tracking data for a predefined duration in response to a loss of communication with the local law enforcement server, ensuring that no tracking information is lost during connectivity interruptions. In another embodiment, the device utilizes internal memory to buffer location tracking data, retaining records until network connectivity is restored and the data can be transmitted. The storage duration may be adjustable based on available memory capacity and operational requirements, and this feature can be implemented in various wearable formats, such as wristbands, necklaces, or rings. Additionally, the device may provide a notification to the user or enforcement authorities when communication is reestablished and buffered data is successfully transmitted, thereby maintaining transparency and continuity in compliance monitoring.

Aspect 22: The method of any of aspects 1 through 21, wherein the wearable tracking device is configured to generate a tamper alert in response to detecting a magnetic field disruption near the magnetic lock. In one embodiment, the wearable tracking device is configured to generate a tamper alert in response to detecting a magnetic field disruption near the magnetic lock, thereby enabling rapid notification to enforcement authorities of potential unauthorized removal attempts. In another embodiment, the device incorporates a magnetic field sensor that continuously monitors the area surrounding the magnetic lock, and any abnormal fluctuation or disruption triggers an immediate tamper alert. This tamper alert feature can be implemented in various wearable formats, such as wristbands, necklaces, or rings, and may be supplemented by additional security mechanisms, such as logging the event with a timestamp and device identification for compliance review. Additionally, the system may transmit the tamper alert via multiple communication channels, including satellite or cellular links, to ensure prompt delivery regardless of the traveler's location.

Aspect 23: The method of any of aspects 1 through 22, wherein the wearable tracking device is configured to transmit a compliance status update to the local law enforcement server in response to detecting entry into or exit from a predefined geofence. In one embodiment, the wearable tracking device is configured to transmit a compliance status update to the local law enforcement server in response to detecting entry into or exit from a predefined geofence, enabling real-time monitoring of the tourist's movements relative to authorized travel zones. In another embodiment, the device may store geofence parameters locally and automatically generate compliance status updates upon crossing geofence boundaries, even during temporary network outages, with updates transmitted once connectivity is restored. This compliance status feature can be implemented in various wearable formats, such as wristbands, necklaces, or rings, and may be supplemented by additional criteria, such as time-based restrictions or event-driven triggers, to enhance the accuracy and responsiveness of compliance monitoring. Additionally, the system may log each compliance status event for audit and enforcement purposes, ensuring a reliable record of the tourist's adherence to travel authorizations.

Aspect 24: The method of any of aspects 1 through 23, wherein the wearable tracking device is configured to transmit a periodic status report to the local law enforcement server, the periodic status report including location tracking data and a device integrity status. In one embodiment, the wearable tracking device is configured to transmit a periodic status report to the local law enforcement server, with the periodic status report including location tracking data and a device integrity status. In another embodiment, the device may allow for adjustable reporting intervals, enabling authorities to set the frequency of periodic status reports based on operational requirements or battery capacity. The periodic status report feature can be implemented in various wearable formats, such as wristbands, necklaces, or rings, and may be supplemented by additional information, such as battery level, tamper detection events, or compliance status. Additionally, the device may support secure transmission of periodic status reports using encrypted communication channels, ensuring the confidentiality and integrity of the data sent to the local law enforcement server.

Aspect 25: The method of any of aspects 1 through 24, wherein the wearable tracking device is configured to deactivate the magnetic lock in response to receiving an authorized removal command from the local law enforcement server. In one embodiment, the wearable tracking device is configured to deactivate the magnetic lock in response to receiving an authorized removal command from the local law enforcement server, thereby enabling secure and controlled removal of the device. In another embodiment, the device may require verification of both local and federal traveler authorizations before deactivating the magnetic lock, ensuring compliance with multi-jurisdictional protocols. The deactivation mechanism can be implemented in various wearable formats, such as wristbands, necklaces, or rings, and may utilize electromagnetic, mechanical, or hybrid locking systems to enhance security. Additionally, the device may log each removal event, including timestamp and authorization details, to provide an audit trail for compliance verification and enforcement actions.

Aspect 26: The method of any of aspects 1 through 25, wherein the wearable tracking device is configured to transmit an alert to the local law enforcement server in response to detecting a predefined pattern of physical impact on the device. In one embodiment, the wearable tracking device is configured to transmit an alert to the local law enforcement server in response to detecting a predefined pattern of physical impact on the device, thereby enabling rapid identification of potential tampering or misuse. In another embodiment, the device incorporates impact sensors that monitor for specific force thresholds or sequences, and any detection of a predefined pattern triggers an immediate alert transmission. This alert feature can be implemented in various wearable formats, such as wristbands, necklaces, or rings, and may be supplemented by additional security mechanisms, such as logging the event with a timestamp and device identification for compliance review. Additionally, the system may transmit the alert via multiple communication channels, including satellite or cellular links, to ensure prompt delivery regardless of the traveler's location.

Aspect 27: A non-transitory computer-readable medium storing code for verifying movement of tourists for real-time monitoring, the code comprising instructions executable by a processor to perform a method of any of aspects 1 through 26.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label, irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media include both non-transitory computer storage media and communication media, including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A secure tracking system of verifying movement of tourists for real-time monitoring of tourists, the secure tracking system comprising:
a wearable tracking device worn by a tourist, the wearable tracking device comprising:
a GPS device, the GPS device generating location tracking data of the wearable tracking device worn by the tourist;
a magnetic lock securing the wearable tracking device to the tourist;
a bar code for accessing information of the tourist wearing the wearable tracking device; and
a panic button for sending an alert to an enforcement agency from the wearable tracking device; and
at least one processor; and
a memory storing processor-executable instructions, wherein the at least one processor is configured to implement the following operations upon executing the processor-executable instructions:
asynchronously sending a registration message, to a local law enforcement server, based on the location tracking data, the local law enforcement server coupled to a local law enforcement database;
receiving, from the local law enforcement server, locally identifying information associated with the tourist in response to the registration message;
validating the location tracking data based on the locally identifying information associated with the tourist;
asynchronously sending a validation message associated with the validating the location tracking data to a federal law enforcement server, the federal law enforcement server coupled to a federal law enforcement database;
receiving, from the federal law enforcement server, federally identifying information associated with the tourist in response to the validation message;
authenticating the validation message based on the federally identifying information associated with the tourist;
receiving a confirmed traveler request from the tourist;
sending the confirmed traveler request from the tourist to the local law enforcement server;
receiving, from the local law enforcement server, a local traveler authorization associated with the confirmed traveler request, the local traveler authorization being received via a traveler programmable user interface, the local traveler authorization comprising: a secure, encrypted, Internet Protocol (IP) message using encryption hashed with public and private key management;
sending the confirmed traveler request from the tourist to the federal law enforcement server;
receiving, from the federal law enforcement server, a federal traveler authorization associated with the confirmed traveler request, the federal traveler authorization being received via the traveler programmable user interface, the federal traveler authorization comprising: a secure, encrypted, Internet Protocol (IP) message using encryption hashed with public and private key management; and
performing an authorized tourist verification in accordance with the local traveler authorization and the federal traveler authorization, the performing of the authorized tourist verification using a secure internal switch and being associated with the wearable tracking device worn by a tourist.

2. A secure tracking system for verifying movement of tourists for real-time monitoring, the secure tracking system comprising:
a wearable tracking device worn by a tourist, the wearable tracking device comprising:
a GPS device, the GPS device generating location tracking data of the wearable tracking device worn by the tourist;
a magnetic lock securing the wearable tracking device to the tourist; and
a panic button for sending an alert to an enforcement agency from the wearable tracking device; and
at least one processor; and
a memory storing processor-executable instructions, wherein the at least one processor is configured to implement the following operations upon executing the processor-executable instructions:
asynchronously sending a registration message, to a local law enforcement server, based on location tracking data of a tourist, the local law enforcement server coupled to a local law enforcement database;
receiving, from the local law enforcement server, locally identifying information associated with the tourist in response to the registration message;
validating the location tracking data based on the locally identifying information associated with the tourist;
asynchronously sending a validation message associated with the validating the location tracking data to a federal law enforcement server, the federal law enforcement server coupled to a federal law enforcement database;
receiving, from the federal law enforcement server, federally identifying information associated with the tourist in response to the validation message;
authenticating the validation message based on the federally identifying information associated with the tourist;
receiving a confirmed traveler request from the tourist;
sending the confirmed traveler request from the tourist to the local law enforcement server;
receiving, from the local law enforcement server, a local traveler authorization associated with the confirmed traveler request, the local traveler authorization being received via a traveler programmable user interface, the local traveler authorization comprising: a secure, encrypted, Internet Protocol (IP) message using encryption hashed with public and private key management;
sending the confirmed traveler request from the tourist to the federal law enforcement server;
receiving, from the federal law enforcement server, a federal traveler authorization associated with the confirmed traveler request, the federal traveler authorization being received via the traveler programmable user interface, the federal traveler authorization comprising: a secure, encrypted, Internet Protocol (IP) message using encryption hashed with public and private key management; and
performing an authorized tourist verification in accordance with the local traveler authorization and the federal traveler authorization, the performing of the authorized tourist verification using a secure internal switch and being associated with a wearable tracking device worn by a tourist.

3. The secure tracking system for verifying movement of tourists of claim 2, wherein the location tracking data is generated by a GPS-enabled computer chip within the wearable tracking device.

4. The secure tracking system for verifying movement of tourists of claim 2, wherein receiving the locally identifying information comprises receiving the locally identifying information in response to a scan of a barcode affixed to the wearable tracking device using a restricted-access application operated by a local authority.

5. The secure tracking system for verifying movement of tourists of claim 2, further comprising, upon detecting an interruption of an electrical tamper-detection conductor within the wearable tracking device, asynchronously sending a tamper alert to at least one of the local law enforcement server and the federal law enforcement server.

6. The secure tracking system for verifying movement of tourists of tourists of claim 2, wherein receiving the confirmed traveler request from the tourist comprises detecting two consecutive activations of a panic button on the wearable tracking device.

7. The secure tracking system for verifying movement of tourists of tourists of claim 2, wherein asynchronously sending at least one of the registration message or the validation message is performed via a satellite communication link.

8. The secure tracking system for verifying movement of tourists of tourists of claim 2, further comprising buffering the location tracking data within the wearable tracking device upon loss of network connectivity, and transmitting the buffered location tracking data upon restoration of connectivity.

9. The secure tracking system for verifying movement of tourists of claim 2, wherein validating the location tracking data comprises comparing the location tracking data to a geofence of authorized travel areas retrieved from the local law enforcement database.

10. The secure tracking system for verifying movement of tourists of claim 2, wherein performing the authorized tourist verification using the secure internal switch comprises actuating a magnetic lock of the wearable tracking device to permit removal of the wearable tracking device.

11. The secure tracking system for verifying movement of tourists of claim 2, further comprising dynamically adjusting a transmission interval for asynchronously sending the registration message based on a residual battery capacity of the wearable tracking device.

12. The secure tracking system for verifying movement of tourists of claim 2, wherein performing the authorized tourist verification further comprises verifying a digital signature included in the federal traveler authorization using a stored federal public cryptographic identifier.

13. The secure tracking system for verifying movement of tourists of claim 2, wherein the wearable tracking device comprises a steel fiber reinforcement to prevent deliberate physical damage or unauthorized removal.

14. The secure tracking system for verifying movement of tourists of claim 2, wherein the wearable tracking device is selected from the group consisting of a wristband, a smart necklace, and a smart ring.

15. The secure tracking system for verifying movement of tourists of claim 2, wherein the registration message includes a serial identification code specifically linked to the wearable tracking device.

16. The secure tracking system for verifying movement of tourists of claim 2, further comprising encrypting all personal and location data stored within the wearable tracking device using public and private cryptographic key management.

17. The secure tracking system for verifying movement of tourists of claim 2, wherein the wearable tracking device is configured to restrict removal or installation to authorized checkpoints.

18. The secure tracking system for verifying movement of tourists of claim 2, wherein further comprising comparing the location tracking data to a geofence of authorized travel areas retrieved from the local law enforcement database and generating a compliance status based on the comparison.

19. The secure tracking system for verifying movement of tourists of claim 2, further comprising encrypting the location tracking data and personal information stored within the wearable tracking device using public and private cryptographic key management prior to transmitting the data to the local law enforcement server.

20. The secure tracking system for verifying movement of tourists of claim 2, wherein the performing the authorized tourist verification in accordance with the local traveler authorization and the federal traveler authorization comprises actuating a secure internal switch associated with a wearable tracking device worn by the tourist.
